(19) United States
(12) Patent Application Publication
(10) Pub. No.: US 2014/0324553 A1
(43) Pub. Date: Oct. 30, 2014

(54) Computer-Assisted Method for Adaptive, Risk-Based Monitoring of Clinical Studies

(71) Applicant: Michael Joseph Rosenberg, Port Orange, FL (US)

(72) Inventor: Michael Joseph Rosenberg, Port Orange, FL (US)

(21) Appl. No.: 13/956,680

(22) Filed: Aug. 1, 2013

Related U.S. Application Data
(60) Provisional application No. 61/678,217, filed on Aug. 1, 2012.

(51) Int. Cl. G06Q 10/06; G06F 19/00

(52) U.S. Cl. CPC G06Q 10/06395; G06F 19/363
USPC 705/7.41

(57) ABSTRACT

A computer-assisted method is described for continuously assessing the quality of field data in a clinical study, identifying areas of weakness and specific sites where performance may be less than desirable, and flexibly allocating resources to address the problems, including the need to travel to the site to either check data or address problem areas. This method involves specification of key performance indicators that include elements that, preferentially, can be measured from a central location and do not require physical presence at the site to be checked. Such indicators can be continuously evaluated for correlation with desired performance levels, and modified accordingly. This approach thus is both risk-based and adaptive, and specifically enables clinical trial managers to address quality issues without the need to travel to the sites.

### CROSS-REFERENCE TO RELATED APPLICATIONS

This application claims priority to U.S. Provisional Application No. 61/678,217, filed Aug. 1, 2012, which hereby is incorporated by reference herein in its entirety.

### BACKGROUND OF THE INVENTION

1. Field of the Invention

The invention relates to the field of both “adaptive” and conventional clinical trials (of, e.g., a pharmaceutical product or a medical device). “Adaptive” clinical trials utilize and provide very timely information about clinical outcomes and site performance, typically by continuously monitoring outcomes and continuously adjusting the way the trial is conducted. Thus, the course of such clinical investigations can be altered based on experience as a study progresses. Conventional clinical trials typically are managed with more limited access to timely information about clinical outcomes and site performance, and limited ability to adjust the way the trial is conducted. The success of both adaptive and conventional clinical trials depends on optimizing data quality, minimizing timelines for trial completion and maximizing efficiency, especially with regard to use of the sponsor's resources.

Issues in data quality and site compliance with the study protocol and regulatory requirements increase time required to complete a study. Unforeseen developments in the field can increase both data and procedural errors. Correction of both data errors and procedural errors consumes sponsor resources. The ability to correct errors is dependent on access to timely information about what is happening in the field and the ability to respond dynamically to unforeseen developments. Therefore, there is a need for a method that accelerates detection and correction of errors and allows rapid, dynamic response based on changing conditions.

The invention provides a computer-assisted method for continuously assessing the field data collected in a clinical trial, in order to optimize the quality and timeliness of such data. The invention involves the collection of information to identify areas of weakness in the study and/or at specific clinical sites, where performance may be less than desirable, acceptable, or the norm for an individual study. The invention provides for the adaptive conduct of clinical trials in that, based on analysis of such collected information, resources flexibly are allocated to address the identified problems, whether foreseen or unforeseen, for example, by adjusting the need to travel to the site to either check data or address problem areas in collecting data.

2. Description of the Related Art

Increasingly, clinical research is under constraints to improve the ability to manage complex clinical trials, which are generally geographically diverse. Doing so requires continuous measurement of numerous performance indices, an easy reporting mechanism, and the ability to intervene or otherwise change processes, practices, or other elements to improve performance.

In particular, clinical evaluation of new drugs requires ensuring the accuracy of data collected in the field, since such information regarding both efficacy and safety is the basis for progression through clinical testing and marketing approval by regulatory bodies.

In addition to the primary data (relating to, e.g., efficacy and safety), a secondary form of data is meta-data, which can be defined as additional data that can be used to measure various performance criteria associated with the primary data. These include (but are not limited to) benchmarks such as the number of data queries generated by a clinical site, time to respond to queries, time to submit data following a patient visit, and other quality measures.

Given the emphasis on improving the efficiency of clinical trials, the timeliness and accuracy of both primary data and meta-data are increasingly important as a means of ensuring timely development decisions. This is particularly critical for adaptive approaches that demand reliable, quick data to serve as the basis for decision making and progression. Examples include dose-response studies that utilize pruning, interim analyses, and Bayesian analyses. In addition, the timeliness and reliability of safety and other data are increasingly important as a basis for the immediacy of decision-making generally affecting development, and are increasingly important for reducing the time, cost, and risk of pharmaceutical development and other clinical investigations.

Both regulatory and pragmatic considerations require reliance on accurate clinical data. The Gold Standard for such data is “source data,” which is defined by regulators as the first place a data point is recorded. This is often found in patient charts. These data then are copied onto Case Report Forms (“CRF”), an individual form for collecting data as part of a study; these can be paper or electronic (e.g., computerized, tablets, digital pens). Usual industry practice is to have trained personnel regularly sent to the field to check that values in the database, whether first entered on an electronic data collection system or transcribed from paper CRFs, match those as originally recorded, with any necessary changes to the database being made during the course of data validation and correction—a process known as Source Data Verification (“SDV”). This is an expensive process, generally accounting for approximately one-third of total study costs.

The conventional approach to SDV has a number of limitations. First, the availability of “clean” data for decision-making is slow, usually a matter of weeks to months after the data are first recorded. Second, it necessitates that a similar approach be taken, and comparable resources expended, for all sites and often all data fields, regardless of the importance of a particular field to the study and whether or not a particular site executes well or poorly. Third, this is a reactive process, waiting for errors to occur, correcting them, and waiting for errors to occur againg—which are often the same types or patterns of errors. Fourth, it is very expensive, generally requiring highly trained individuals to travel to sites, which includes a good deal of unproductive travel time. Individuals (known as field monitors or Clinical Research Associates [“CRA”]) who generally perform these tasks spend three-quarters of their time performing SDV, which makes the position very demanding in terms of a high proportion of time spent traveling. CRAB are generally young, just starting their careers, and lacking either the time on-site or the management experience to be able to effectively manage performance problems. Finally, SDV is a tedious task, ill-suited to human responses because it requires long stretches of intense attention and infrequent finding of errors. This is reflected in the fact that errors are commonly discovered after completion of the study, during statistical cleaning and examination, and examination of patterns and discrepancies in data. In addition, the number of errors missed entirely is unknown, and in some cases audit by internal staff or regulators has resulted in Notices of Deficiencies which, in some cases, have invalidated entire studies.

US Patent Application Publication 2008/0270420A1 (the “'420 application”), which is of common inventorship herewith, provides a system and method for streamlining SDV. The invention described in the '420 application provides an electronic means of organizing, checking and comparing data, and writing and tracking discrepancies with respect thereto, as well as maintaining a corresponding audit trail. Thus, the '420 application seeks to replace much of the work presently done by hand with a uniform, standardized electronic process, thereby improving its efficiency. However, the '420 application (the disclosure of which is incorporated by reference herein in its entirety), reflects a static approach, rather than an adaptive approach, to streamlining SDV.

US Patent Application Publication 2008/0270181A1 (the “'181 application”), which also is of common inventorship herewith, generally describes a method and system for conducting adaptive clinical trials, including (1) flexible means for collecting data from remote sites; (2) processing, tracking, and validating such data and meta-data at a processing location; (3) interacting between central and remote sites to manage and resolve data discrepancies; (4) reporting data to managers and remote sites; and (5) facilitation of special services to clinical research such as flexible randomization of patients, patient participation eligibility verification and double-blind trials. However, the adaptive approach of the '181 application (the disclosure of which also is incorporated by reference herein in its entirety), is not specifically directed to optimizing the collection or verification of data.

Tantsyura et al., Risk-based Data Source Verification Approaches: Pros and Cons. Drug Info J 2010:44; 745-56 (“Tantsyura”) discloses a “risk-based” approach to SDV (e.g., differentiating between critical data vs. non-critical data for a particular study), and suggests a mix of random, decreasing, and other algorithms so that not all data would be subject to the same level of SDV. Thus, Tantsyura suggests that greater SDV resources be applied to those data that involve greater “risk,” while fewer SDV resources are applied to those data considered to involve less risk. However, although such approach is risk-based, it is not really “adaptive.”

Thus, the manner in which the prior art addresses SDV suffers from the following shortcomings:

(1) The standard for assessing quality requires a visit to the field to conduct on-site source data verification, so the basis of adjustment requires the same expensive, time-consuming, and tedious process originally required.
(2) The on-site source verification is conducted only at intervals, normally four to six weeks or more, meaning that any adjustments can be made only at long, discrete intervals, and the basis of assessment is something that occurred weeks ago, rather than what is occurring today.
(3) These approaches fail to identify or act in a timely manner or sometimes to provide the perspective that enables pattern recognition important for management to address patterns such as those that might be common to multiple data fields, sites, countries, or other groupings.

The biggest problem with the prior art's “one-size-fits-all” approach to SDV is that the lack of timely information on the type and frequency of problems precludes any ability to adjust the intensity and interval of field monitoring to the frequency and type of errors committed. Thus, it would be desirable to have an approach to field monitoring and SDV that is both risk-based and adaptive.

### SUMMARY OF THE INVENTION

The above-identified deficiencies of the prior art are remedied by the present invention, which takes into account a series of background risk factors (historical, experience-based, or other, all identified before a trial is started), as well as continuously measured performance metrics during a trial. Based on these risk factors and performance measurements, the invention establishes individual and composite risk scores, and provides a means of adjusting the intensity and interval of field monitoring throughout the course of a clinical trial. It does so by starting with background risk factors where possible, continuously collecting a broad range of site performance metrics as well as study data itself, sifting both for patterns of errors and correlations between data and performance metrics, and then allocating resources according to performance levels.

Performance metrics may be specific individual factors, or a combination of factors, or a composite summary score. The purpose in each case is to enable supervisory personnel to identify problem areas within a site, and/or poorly performing sites in general, and/or other patterns which allow them to allocate resources immediately, before having to visit a site, in a manner proportional to the type and magnitude of the problem. The immediacy of feedback (seconds or minutes to hours, as opposed to weeks to months or even years) is an important means of correcting errors and assuring that the same or other errors, that otherwise likely would occur in the absence of correction, do not occur. Key to reducing such errors is the timely ability to contact an individual or site regarding a particular question or error on a CRF, or to address a pattern of errors that may have occurred as a result of inadequate site training, personnel issues, CRF design, or any other problem. A notable benefit of the invention is that it allows most of these oversight functions to be achieved immediately by centralized, in-house specialists without the need to travel to the sites. An additional benefit of this method is to trigger specific, traceable task lists and instructions to guide study management personnel on how to address problems that occur and to fix the root problem that caused it.

Accordingly, in a first embodiment of the invention, a risk-based, computer-assisted method is provided for adaptively adjusting the interval and/or intensity of field monitoring in a medical clinical trial conducted at one or more sites. The method comprises the steps of:
(a) specifying
   (i) one or more risk factors, each associated with a type of error likely to be made during performance of the clinical trial,
   (ii) a weighting factor for each risk factor, based on the degree of importance of such risk factor,
   (iii) an Acceptable Quality Level for each risk factor, wherein such Acceptable Quality Level represents an acceptable error rate, and
   (iv) an initial interval and intensity of field monitoring for one or more sites participating in the clinical trial;
(b) measuring the error rate for each type of error or risk factor for one or more sites; and, optionally,
(c) based on the nature and extent of errors measured in step (b), generating a list of corrective actions to be taken at or by one or more of the sites.

In a second embodiment of the invention, step (b) of the method further comprises
(i) comparing such error rate with the corresponding Acceptable Quality Level for the applicable risk factor, and
(ii) calculating a discrepancy score based on the difference between the error rate and the corresponding Acceptable Quality Level for such risk factor.

In a third embodiment of the invention, the method further comprises the step of:
(d) calculating a site performance index for one or more sites, based on the discrepancy scores calculated in step (b)(ii) for each risk factor, with each such discrepancy score weighted according to the weighting factor specified in step (a)(ii).

In a fourth embodiment of the invention, the method further comprises the steps of:
(e) comparing the site performance indices for one or more sites, by ranking the respective site performance indices or comparing each to a desired standard of performance, in order to differentiate better-performing from worse-performing sites; and, optionally,
(f) analyzing the respective site performance indices in order to evaluate (or re-evaluate) the risk factors that best predict performance.

In a fifth embodiment of the invention, the method further comprises the step of:
(g) increasing, decreasing, or maintaining the intensity and/or interval of field monitoring at one or more sites, based on (i) the respective site performance indices and/or (ii) the nature of the errors measured at the respective sites.

In a sixth embodiment of the invention, the method further comprises the steps of:
(h) measuring various additional quality indices, including trend or pattern information, observed during the continued performance of the clinical trial; and optionally,
(i) analyzing the quality indices or trend or pattern information in order to evaluate (or re-evaluate) the most predictive risk factors for determination of site performance.

In a seventh embodiment of the invention, step (a)(iv) of the method further comprises evaluating background risk factors and/or the nature of the data to be obtained in the clinical trial.

In an eighth embodiment of the invention, the risk factors utilized in the method are selected from the group consisting of data recording errors, procedural errors, and non-data (or meta-data) events.

In a ninth embodiment of the invention, the corrective actions in the method are selected from the group consisting of (i) actions that can be addressed immediately and/or remotely and (ii) actions that require on-site activity.

In a tenth embodiment of the invention, all or part of the list of corrective actions is generated by software that has been pre-programmed to address errors that are commonplace in clinical trials.

In an eleventh embodiment of the invention, step (c) of the method further comprises the use of software to automatically schedule the performance of the corrective actions.

In a twelfth embodiment of the invention, step (f) of the method further comprises generating a linear or non-linear multivariable model for calculation of site performance indices.

In a thirteenth embodiment of the invention, the model is refined by replacing (i) measures of site performance that normally would require on-site evaluation, with (ii) surrogate measures of site performance that can be measured remotely.

In a fourteenth embodiment of the invention, step (g) of the method further comprises paying a financial performance “bonus” to one or more better-performing sites and/or applying a financial “penalty” to one or more worse-performing sites.

### BRIEF DESCRIPTION OF THE DRAWINGS

FIG. 1 is a flow chart generally depicting the adaptive, risk-based method of the invention.

FIGS. 2A and 2B, taken together, show a spreadsheet page for identifying various risk factors in a clinical trial, applying a weight to each of these, and providing other information that would be used to adjust the level of monitoring during a clinical trial.

FIG. 3 is a database printout or screenshot, identifying particular critical data fields for monitoring in accordance with the invention.

FIG. 4 provides a listing of various “predictors” that can be used to measure site performance during a clinical study.

FIG. 5 is a printout or screenshot of a report containing an exemplary table of corrective “action items,” generated based on the identification and/or measurement of errors in performance of a study.

FIG. 6 is a printout or screenshot of the output of an “automated scheduler” of corrective actions, generated based on the content of the report in FIG. 5.

FIG. 7 is a printout or screenshot showing an expanded view of the timing and general nature of the various action items that have been scheduled with respect to just one of the clinical sites (i.e., Site 41), per FIG. 6.

FIG. 8 is a bar graph, comparing the overall Site Performance Index (“SPI”) as calculated for each of a plurality of clinical sites, 1 through 4.

FIG. 9 is a bar graph wherein the SPIs from FIG. 8 have been inverted and normed to a 1-100 scale.

FIG. 10 is a printout or screenshot of a report containing an exemplary table of corrective “action items,” similar to that in FIG. 5, but specifically associated with the data in Working Example 1 below.

FIG. 11 is a bar graph showing the SPIs for the same four sites as in FIG. 9, based on performance during the following month, after corrective actions have been taken.

FIG. 12 is a bar graph showing the SPIs for the same four sites as in FIG. 11, based on performance during a third month, after further corrective actions have been taken.

FIG. 13 is a bar graph showing the “raw” SPIs for the first set of ten patients seen at four different clinical sites.

FIG. 14 is a bar graph showing the respective SPIs for the second set of ten patients seen at the same four sites as in FIG. 13.

FIG. 15 is a bar graph showing the respective SPIs for the third set of ten patients seen at the same four sites as in FIGS. 13 and 14.

FIG. 16 is a bar graph showing the “raw” SPIs for the first two months of a study at ten different clinical sites.

FIG. 17 is a bar graph, wherein the same SPIs from FIG. 16 are presented in descending order (i.e., worst performer through best performer).

FIG. 18 is a bar graph of SPIs for the same sites shown in FIG. 16, after a third month of the study.

FIG. 19 is a bar graph of SPIs for the same study as in FIG. 18, after a fourth month of the study. Superimposed on the graph is a “bonus marker” line, which more clearly delineates which sites have earned a performance bonus.

FIG. 20 is a bar graph wherein the SPIs from FIG. 16 have been inverted and normed to a 1-100 scale.

FIG. 21 is the same bar graph as FIG. 20, but includes additional diagnostic information, with each of the bars segmented according to component domain scores for data (dots), procedure (horizontal lines), safety (wavy lines), and timing (diagonal lines).

### DETAILED DESCRIPTION OF THE INVENTION

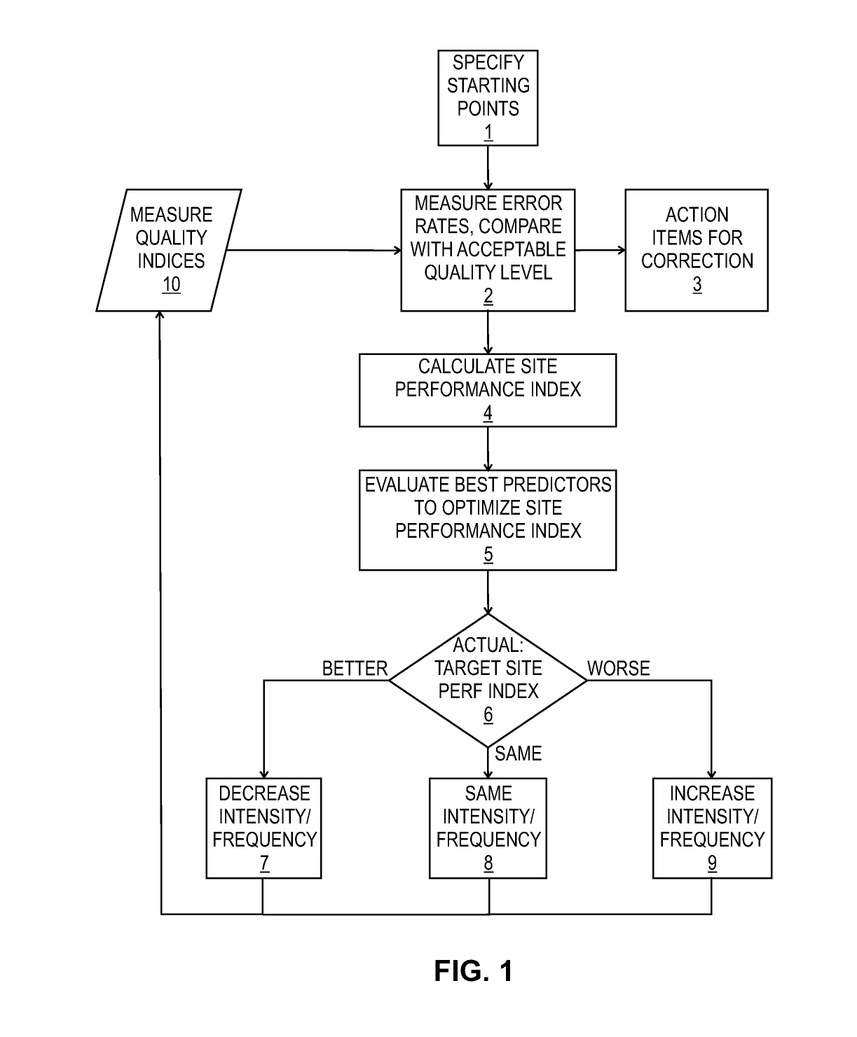

The general method of the invention is represented in FIG. 1, starting with specifying 1 starting points. These include key risk factors, Acceptable Quality Levels (AQL) for each, and initial monitoring interval and intensity prior to initiation of a clinical study.

The initial interval and intensity of data monitoring is determined before the start of a study, based on the following two criteria:
Background risk factors: These are factors that experience or other inputs (e.g., FDA audits, historical, or other sources) suggest may alter the risk of data errors or performance quality (and therefore would affect the degree of starting monitoring intensity). Examples of background risk factors include novelty of drug, study phase, severity of illness in population to be studied, existing co-morbidities, sponsor relationship with regulatory bodies, experience of investigators and site coordinators, and similar issues. These and other factors are listed, and then a weight can be attached to each. The weighting of each risk factor can be quantitatively assessed through various means or subjectively assigned or simply specified with equal weights. As an alternative, no risk factors need be specified, in which case all sites receive the same degree of monitoring and other management. This neutral initial weighting of risk factors may be conservative and begin at or about 100%, or it may be that an arbitrary starting point is selected and then the intensity is adjusted up or downward depending on subsequent measurements detailed below.
Nature of the data to be obtained: The invention also takes into account the relative importance of various types of data to be obtained in a clinical study. Specifically, certain data are directly related to study outcomes and factors that modify those outcomes (“critical data”), while other data are defined as “non-critical.” As a starting point for the invention's risk-based approach, the rate of monitoring for both types of data is established, based on subjective considerations. For example, a conservative approach might start at 100% of all data, both critical and non-critical. A moderate approach might include 100% monitoring of critical data and 20% monitoring of non-critical data. Alternatively, a liberal starting point might include monitoring 50% of critical data and 0% of non-critical data. Each of these approaches depends on many individual factors (such as risk to patient, whether the study involves a completely new drug or a just a modification of an existing drug, location of clinical sites, and other factors).

Once an initial, risk-based level of monitoring has been determined based on the above-described considerations, it is implicit in the adaptive nature of the invention that this level desirably may be adjusted upwards or downwards as the study proceeds, in response to developments in the study. Thus, also before initiation of the clinical study, it is necessary to determine the criteria that will be used for making such adjustments. This is accomplished by identifying risk factors likely to be encountered during performance of the study and, for each such “study risk factor,” defining an “Acceptable Quality Level”—deviations from which are to serve as the criteria for adjusting the level of monitoring.

In accordance with the invention, “study risk factors” are factors that are generated during the study, including both direct measures of data quality (such as error rate) and indirect measures (such as experience of site coordinator) that may be associated with data quality. Typically, study risk factors are grouped as follows:
Recording Errors: These include incorrect data points related to critical data fields (such as study endpoints) and non-critical fields that are not related to study endpoints (for example, weight or height, in studies where that factor is not directly related to study endpoints). Such errors can be detected by comparison with source documents either in the field or at a centralized location.
Procedural errors: These are errors related to study documents required by Good Clinical Practices or International Conference on Harmonization study procedures, such as informed consent, investigator licensing, and others. Thus, an example of a procedural error might be the failure to properly complete informed consent documents or to assure that investigators have a current medical license. Such errors can be detected through a centralized document repository (such as that disclosed in the '181 application), copies of key documents submitted, on-site evaluation, or in CRF and other study documents submitted as part of the data collection aspects of a study.
Non-data (or meta-data) events: These may be factors or patterns that themselves are not errors, but are correlated with one of the types of errors noted above. For example, timing of data submission after patient visit, time required for responding to queries or other corrections, errors in completeness of reporting, or other indicators may be correlated with data quality and type of errors as noted above.

For each study risk factor, a weighting and Acceptable Quality Level (AQL) is specified. Weighting may be uniform (e.g., all factors are weighted equally with a multiplier of 1) or certain errors that are more important may be weighted more heavily (for example, a range of multipliers from 1 to 3). For each AQL, the standard of comparison (“Gold Standard”) should be defined, along with whether that standard must be performed on-site or not. Checking source data generally requires a visit to the site, since source data are normally located at each site. AQL is specified based on experience, particulars of the study, experience with a site or therapeutic area, or any other basis. For example, in a study of cardiac disease, cardiac function is a critical assessment that demands a high AQL (say, 98%); in contrast, a patient's height is less important, and an AQL of 80% or even lower may be acceptable.

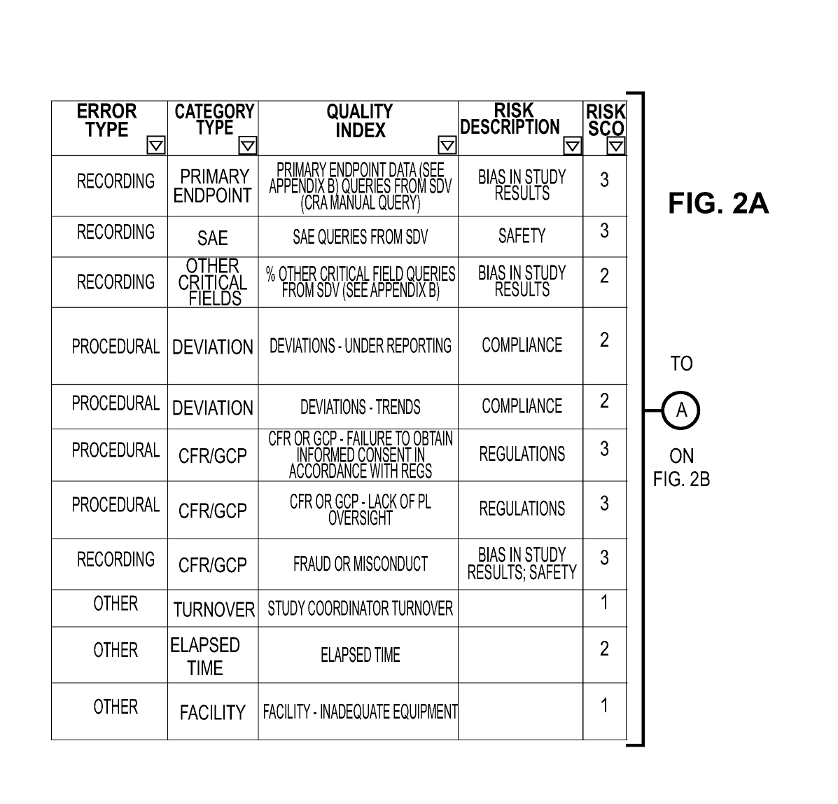

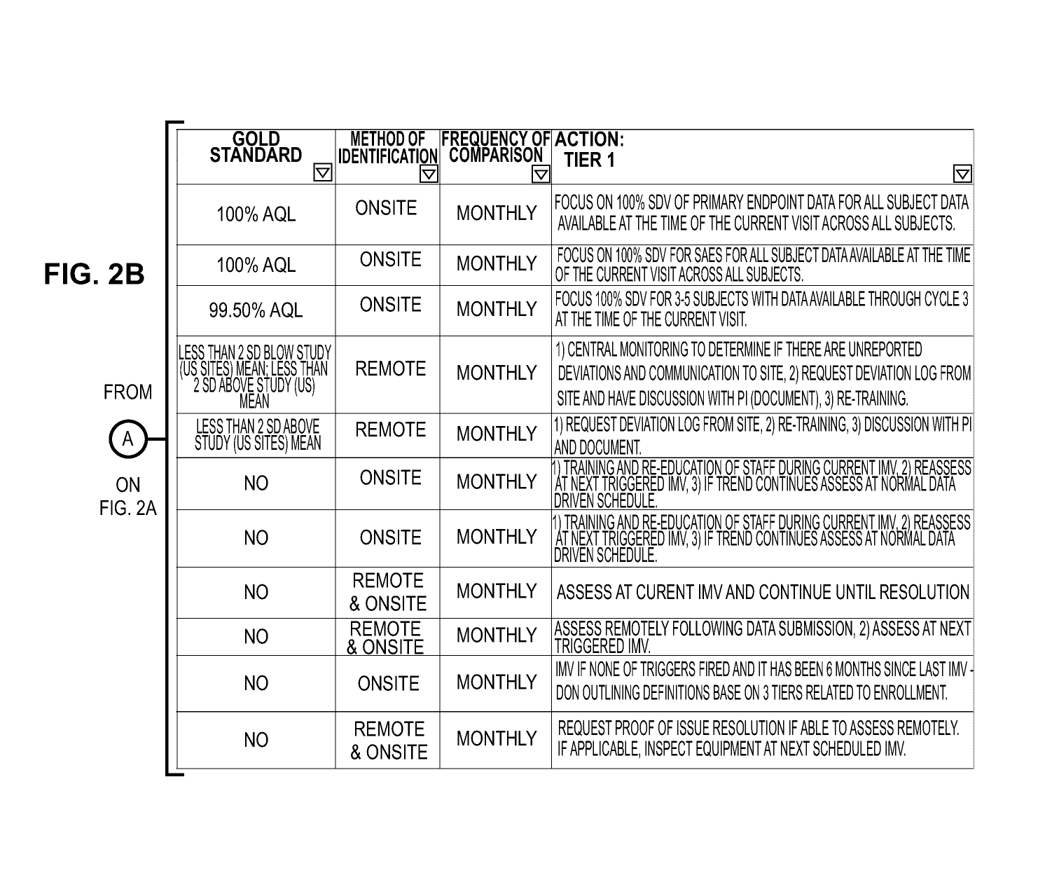

An example of the implementation of this approach is shown in FIG. 2, which is a table of “trigger events” for adjustment of the level of monitoring during a clinical trial. In the spreadsheet shown in FIG. 2, there are fields for
Error Type—including recording errors, procedural errors, and “other” types of errors.
Category Type—for example, certain of the data recording errors relate to a primary endpoint of the study, a serious adverse event (“SAE”), etc. Certain of the procedural errors relate to, e.g., a deviation from the particular study protocol or a failure to complete the proper documentation for regulatory purposes. Certain of the “other” errors relate to such issues as the turnover of key staff members at a clinical site, inadequate equipment at a facility, too much time to report data, etc.
Quality Index—i.e., what performance criterion of the study is affected by the particular error?
Risk Description—what is the nature of the liability created by the particular error (e.g., patient safety, bias in study results, regulatory and/or compliance issues)?
Risk Score—a weighting factor (which can be any number, but preferably a whole number with limited range such as 1 to 3) based on the relative importance of the risk associated with the particular error. For example, in the second row of the spreadsheet, a risk relating to safety is assigned the highest weighting factor (i.e., 3), while in the third row from the bottom of the spreadsheet, a risk relating to turnover of personnel at the study site is assigned the lowest weighting factor (i.e., 1).
Gold Standard—what is the benchmark with respect to the particular Quality Index? For example, in the second row of the spreadsheet, where the Quality Index relates to source data verification of queries relating to serious adverse events, the Gold Standard is “100% AQL,” which means that 100% of all such queries need to be addressed and there are no unreported adverse events. In the fourth-from-the-bottom row of the spreadsheet, where the Quality Index relates to fraud or misconduct, the Gold Standard is “No,” which means that there should be absolutely no fraud or misconduct in the study.
Method of Identification—can the monitoring of the particular error be done remotely (i.e., from a central location), or must it be done on-site?
Frequency of Comparison—what is the initial or “default” interval for SDV for this particular error?
Action: Tier 1—what action needs to be taken, as part of the SDV process, with respect to each error? For example, in the second row of the spreadsheet, which involves a safety issue with a 100% AQL, the corresponding action is to provide 100% SDV (i.e., verification of data with respect to all SAES for all patients) during the on-site SDV visit. In the fourth row of the spreadsheet, which relates to the under-reporting of certain deviations from procedure, and where the Quality Index relates to remaining within two standard deviations from a mean number, the corresponding action is to conduct remote monitoring to determine the magnitude of unreported deviations, and to provide appropriate re-training for site personnel.

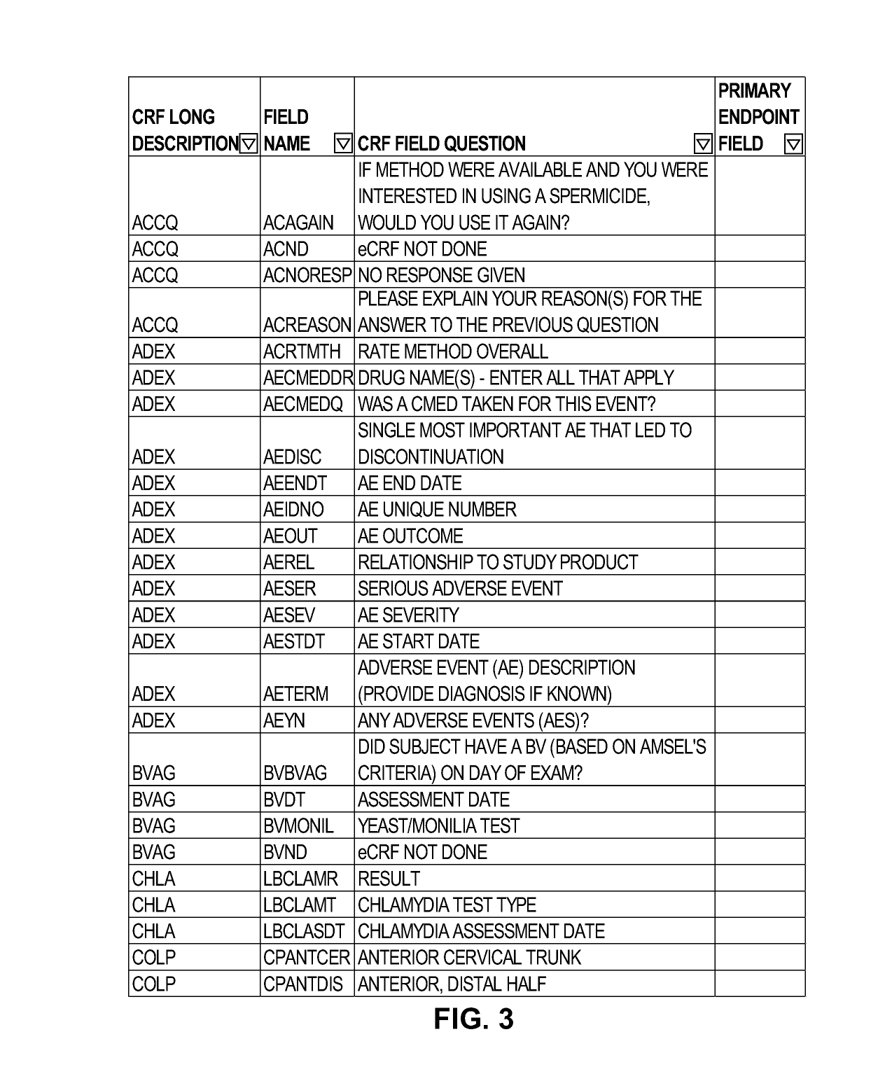

A preferred embodiment of the invention includes the type of database printout shown in FIG. 3, which identifies specific examples of certain critical data fields for monitoring during the study. The fields in the database include identifiers and names for particular entries on a CRF, as well as a recitation of the corresponding “field questions” on the CRF that are intended to elicit critical data. The monitoring would entail a review of the answers to these field questions.

Referring back to FIG. 1, as the study is initiated and progresses, the error rate for each type of error or risk factor is continually measured and compared 2 with the corresponding Acceptable Quality Level. The difference between the two is calculated as a discrepancy score.

As examples, the error rate may be determined by one or more of the following methods, including but not limited to:
a. As part of the data validation process, errors that result in queries (requests sent back to the site for clarification and/or additions) can be tracked for each question, CRF, site, interviewer, and other variables;
b. Time for submission, error correction, and other events can be measured;
c. Procedural errors such as misclassifying a severe adverse event (“SAE”) as merely an adverse event (“AE”), omission of subject signature on consent forms, or the like can be measured.

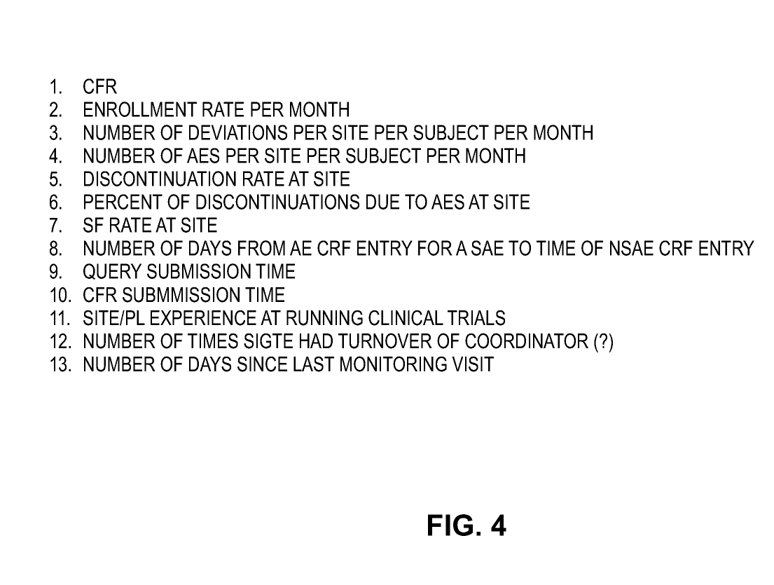

A further preferred embodiment, in the form of a listing of various such “predictors” that can be used to measure site performance—particularly with respect to the types of “non-data events” described above—is shown in FIG. 4. The frequency, type, and patterns and other parameters can be measured to define and continuously refine predictors of errors. These are used to help identify types of error patterns that occur at each site, for the study overall, and for subsets of sites such as those in a certain geographic area.

Returning to FIG. 1, when errors are detected, a specific action item list can be generated 3, letting the individual responsible for the site (the “site manager”) know not only that something needs correction, but exactly how it should be corrected. Thus, the invention advantageously enables individuals with lesser experience to have a framework for choosing the appropriate corrective action(s). This represents an important improvement in the conduct of clinical trials, since the failure or success of typical clinical trials, to date, has hinged on the experience and judgment of the particular staff involved in managing the trials.

The list of action items, as described in the preceding paragraph, may be divided into categories that can be addressed immediately and/or remotely (by telephone, for example), or those that require on-site activity. This capability can further be linked with an automated scheduler for site visits, so that when certain on-site activities are triggered, this (combined with other factors, such as the amount of necessary on-site source verification that has accumulated based on existing and/or expected data) both raises the priority and timing for site visits.

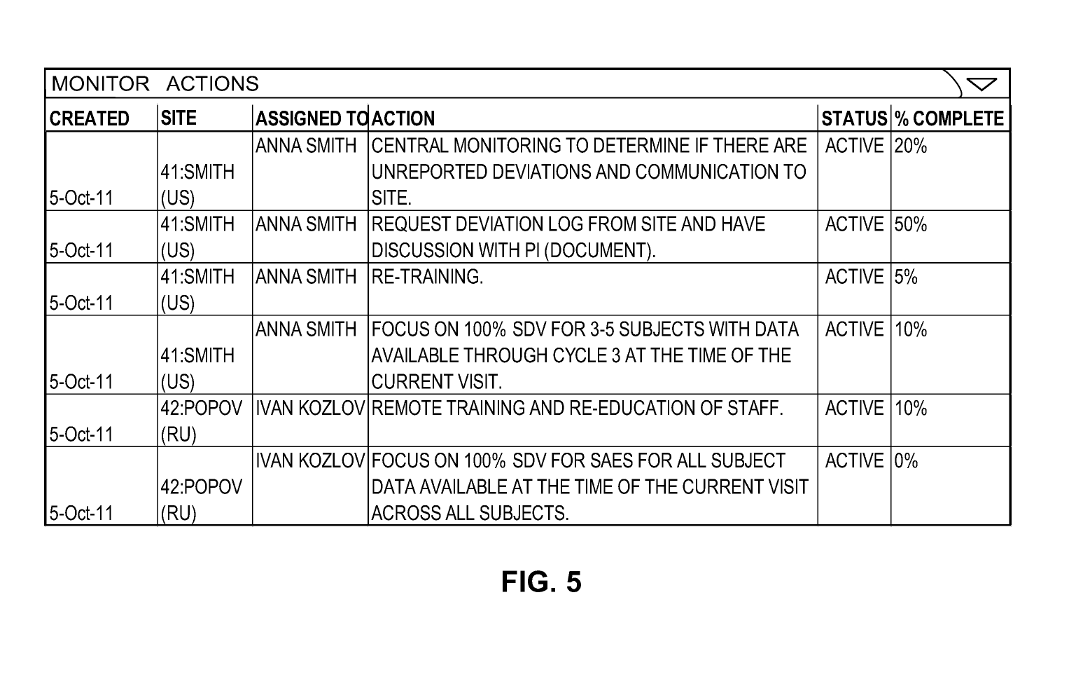

A printout of an exemplary table of action items, generated based on the identification and/or measurement of errors in accordance with the invention, is shown in FIG. 5. The table identifies the individual responsible for taking corrective action, describes the specific action to be taken, and indicates the degree of completion of same.

It should be noted that certain types of errors are universal, to at least some degree, in every clinical study. Thus, in anticipation of such common errors, the invention provides the capability of including “pre-programmed” action items in reports such as those shown in FIGS. 2 and 5. Thus, when such common errors arise, the invention provides a two-fold benefit: (1) A relatively inexperienced field monitor is provided with expert guidance to implement the appropriate corrective actions; and (2) such expert guidance can be obtained without the need for extensive (or even any) consultation with a more experienced, centrally located monitor, since the appropriate corrective actions have been “pre-programmed” into the software utilized in the invention.

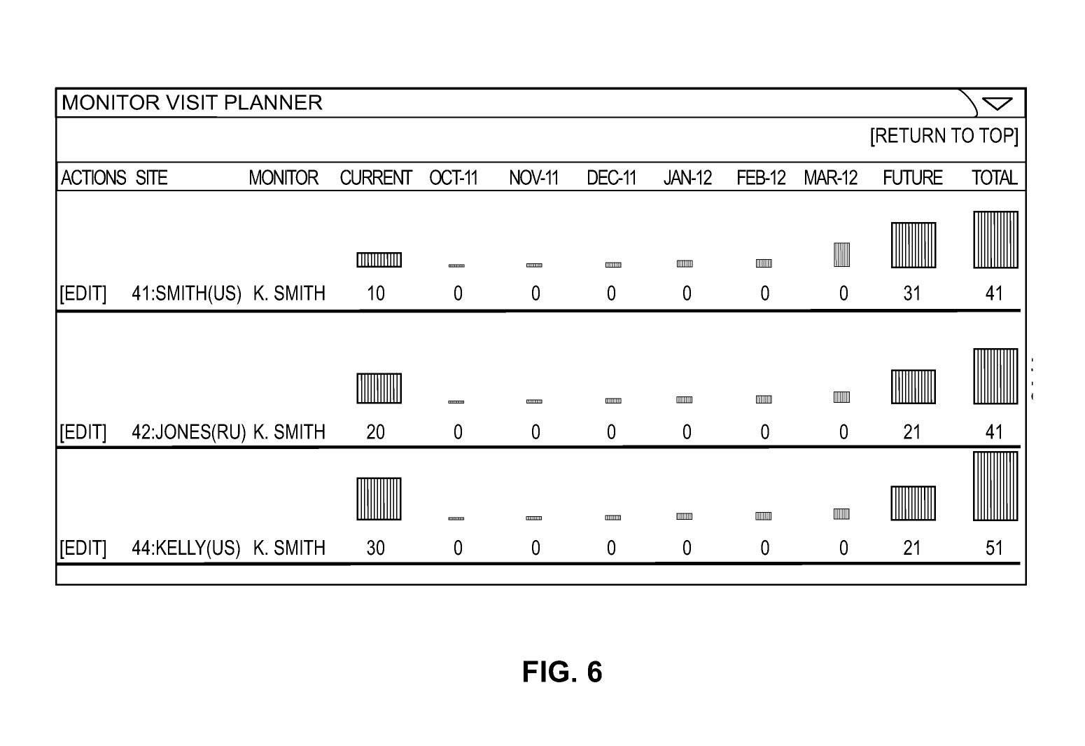

In a further preferred embodiment of the invention, the table of action items shown in FIG. 5 would be linked with an “automated scheduler” of the type shown in FIG. 6. The output of the automated scheduler, as shown in FIG. 6, could include the number of “action items” currently being performed by each field monitor, as well as the number of additional action items assigned to each monitor based on, e.g., information generated and included in a report such as that shown in FIG. 5.

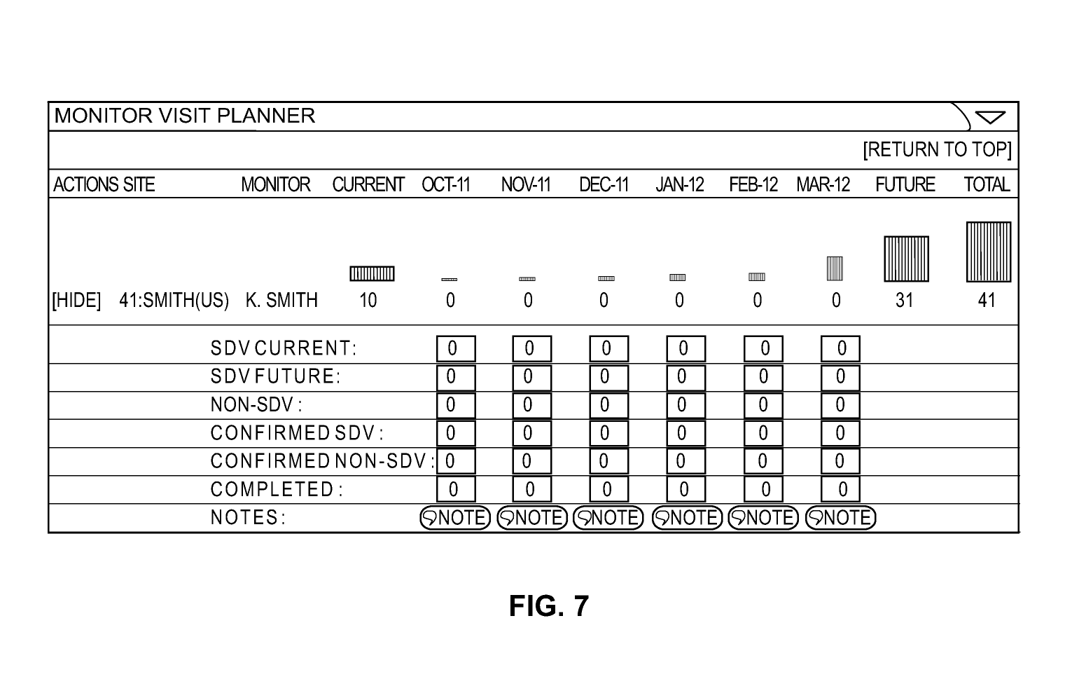

The method of the invention includes additional functionality, in order to provide even more detailed information, in an easy-to-grasp visual format, to a field monitor. An example of this is shown in FIG. 7, which provides an expanded view of the timing and general nature of the action items that have been scheduled with respect to just one of the clinical sites (i.e., Site 41), per FIG. 6.

The next step in the method of the invention, as shown in FIG. 1, is the calculation 4 of a Site Performance Index (SPI). The SPI provides a summary measure of site quality. This can be achieved in a number of ways, but normally this involves measuring the difference between the actual and AQL level of a particular error, considering the weighting factor for each type of error [or errors in each type of data], and summarizing the results. Mathematically, this may be expressed as

$$Site Performance Index ( S P I ) = {a}_{1} {w}_{1} + {a}_{2} {w}_{2} + … {a}_{n} {w}_{n} = {\sum }_{n = 1}^{n} {a}_{a} {w}_{n}$$

$$where$$

$$a = difference from A Q L$$

$$w = weighting factor$$

$$1 , 2 … n = individual risk indicators .$$

The SPI can then be rank ordered and compared with desirable goals. Depending on monitoring resources both centralized and in the field, sites with the worst SPI would receive the highest priority for intervention, whether centrally (by telephone, video or other means) or on-site. The types and consistency of errors will help guide this decision. Another use for this index is as a measure of performance by which sites can be paid based on performance, along with incentives for superior quality work and disincentives for work that falls below a given quality threshold.

The SPI may be compared between sites, studies, or other benchmarks, including external factors, with the rank ordering and degree of variance from desired levels determining the interval of field monitoring as well as what elements are focused on at the time of field monitoring. For example, a particularly important field such as procedural or patient safety errors may be weighted more heavily in risk factors, and thus would result in a worse SPI and would be more likely to trigger a field visit. Others such as data entry errors may be correctable simply with a telephone call.

Those sites with “worse” SPIs than other sites would be subject to more frequent visits, in order to correct quality issues. Note, however, that a site SPI that compares unfavorably to that of other sites nonetheless may be acceptable on an absolute level. In such a case, existing resources could be focused on improving the quality at this site even though it already is within acceptable limits; conversely, this might be taken as a sign to increase the interval between visits to the particular site.

The SPI may also be used in other elements of study conduction. For example, a bonus/penalty system may be established to encourage site performance by providing financial rewards when certain performance goals are met.

An example of SPI calculation in accordance with the invention is provided in Table 1, below, comparing the performance of a number of disparate clinical sites. For example, errors might be measured as in the top section of Table 1. The top section notes the types of errors, as well as the number of errors of each type at each of the respective sites. The middle section of Table 1 shows the numeric deviation from AQL for each type of error for each site, and then applies an appropriate weighting factor thereto. After having specified the units of measurement, weighting, and deviance from AQL for each type of error, the bottom section of Table 1 then shows the calculated deviance score for each site, for each type of error. (In this instance, no negative values for deviance have been allowed, so areas where the sites do better than desired do not offset other areas where they may do more poorly.)

TABLE 1

| | Error type | | | | | | | |
|---|---|---|---|---|---|---|---|---|
| | Critical Data | | | Procedural | | | | |
| | Incorrect | | | Missing | Incorrect | Missed | Missed | Incomplete |
| | value | Missing | Inconsistent | documents | documents | AE | SAE | SAE |
| Site | | | | | | | | |
| 1 | 2 | 0 | 0 | 0 | 0 | 0 | 0 | 0 |
| 2 | 14 | 2 | 1 | 12 | 7 | 4 | 1 | 1 |
| 3 | 5 | 0 | 2 | 2 | 0 | 0 | 0 | 0 |
| 4 | 22 | 9 | 2 | 0 | 0 | 0 | 0 | 0 |
| Deviance from AQL | | | | | | | | |
| AQL | 2 | 0 | 2 | 0 | 0 | 2 | 0 | 1 |
| 1 | 0 | 0 | −2 | 0 | 0 | −2 | 0 | −1 |
| 2 | 12 | 2 | −1 | 12 | 7 | 2 | 1 | 0 |
| 3 | 4 | 0 | 0 | 2 | 0 | −2 | 0 | −1 |
| 4 | 20 | 9 | 5 | 0 | 5 | −2 | 5 | −1 |
| Weighting | 1 | 2 | 1 | 2 | 1 | 2 | 3 | 1 |
| 1 | 0 | 0 | −2 | 0 | 0 | −4 | 0 | −1 |
| 2 | 12 | 4 | −1 | 24 | 7 | 4 | 3 | 0 |
| 3 | 4 | 0 | 5 | 4 | 5 | −4 | 5 | −1 |
| 4 | 20 | 15 | 0 | 5 | 0 | −4 | 0 | −1 |
| Deviance Scores | | | | | | | | |
| Weighting | 1 | 2 | 1 | 2 | 1 | 2 | 3 | 1 |
| 1 | 0 | 0 | 0 | 0 | 0 | 0 | 0 | 0 |
| 2 | 12 | 4 | 0 | 24 | 7 | 4 | 3 | 0 |
| 3 | 4 | 0 | 0 | 4 | 0 | 0 | 0 | 0 |
| 4 | 20 | 18 | 0 | 0 | 0 | 0 | 0 | 0 |

The weighting is a subjective term (in this case, ranging between 1 and 3) that allows each study to have a set of criteria that may be different from another study, even including a similar study. For example, if protocol deviations were considered more serious than CRF submission delay, the former would receive a higher weighting commensurate with the greater emphasis on quality for this performance measure. From Table 1, it can be appreciated that missing SAES is considered the most serious error, indicated by a weighting of 3.

In addition to the advantages described above with respect to the invention (e.g., the ability to provide rapid, expert guidance in order to correct errors in the conduct of the study, even without the benefit of expert study personnel), the invention remarkably is able to achieve this result while decreasing the need for expensive, on-site SDV. To understand how this is accomplished, it is important to differentiate between “direct” and “indirect” risk indicators.

“Direct risk indicators” are defined as those for which the standard of comparison is direct checking by monitoring in the field. For example, the data query (error) rate is a direct indicator of risk. This is measured based on edit checks done centrally, but each query typically has to be verified on-site, by comparison of source data, in order to confirm the occurrence of an error.

In contrast, “indirect risk indicators” are defined as derived measures which do not require verification by field checking. Examples include time between first recording of data in the source document (typically patient record) and submission of the data for verification, whether electronically, by paper, or another method. The benefit of indirect indicators is that these can be continually tracked from a central or remote site and do not require on-site presence as a means of generating comparison values to determine variance from the “Gold Standard.” To the greatest extent possible, the invention advantageously utilizes an analysis of such indirect risk indicators.

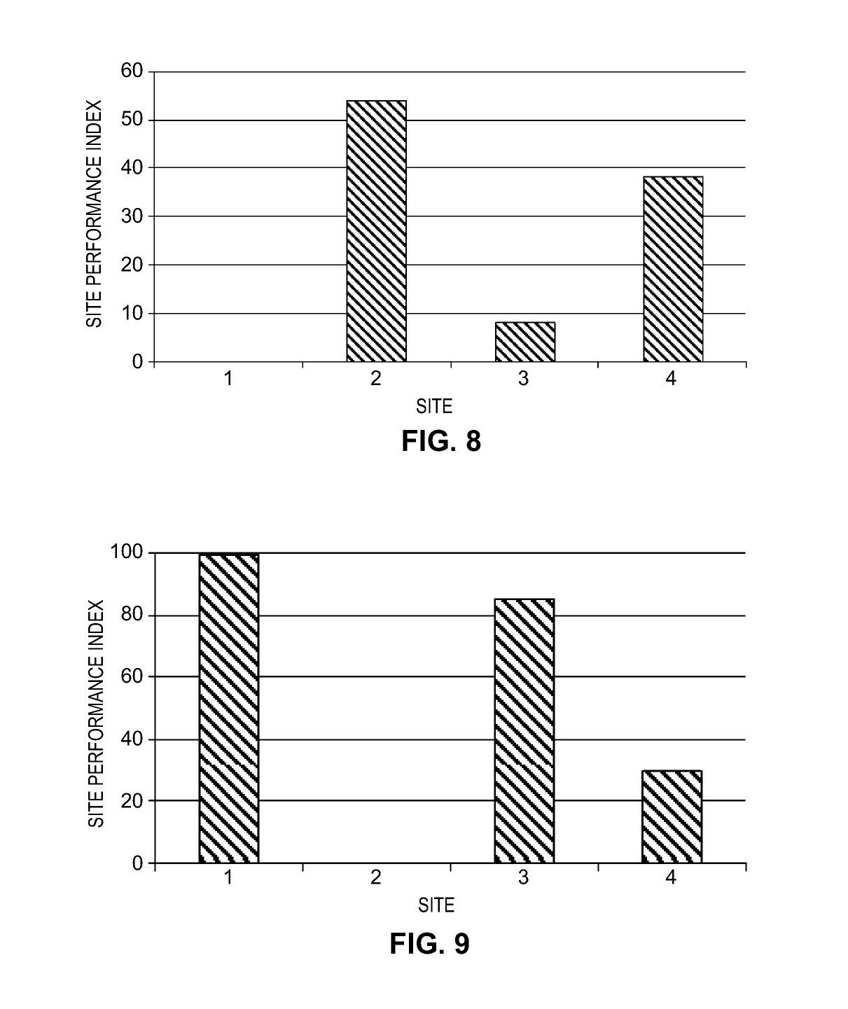

In order to further facilitate the use of SPIs to compare the performance of a plurality of clinical sites, the invention advantageously provides intuitive graphic displays. For example, each row of the bottom section of Table 1 is summed to provide an overall, comparative SPI score for each site, which can be displayed graphically, as shown in FIG. 8. From the bar graph in FIG. 8, it readily can be appreciated that the site with the highest SPI (and thus the highest priority for remedial intervention) is Site 2, followed by Site 4, Site 3, and Site 1.

Once calculated, the “raw” SPIs of FIG. 8 can be normed so that scores fall within a range of 0-100, and/or inverted so that higher scores reflect better performance, or otherwise mathematically transformed in a manner that facilitates intuitive understanding. Application of both these methods (i.e., inversion and norming) to the data above, for example, would result in the bar graph of FIG. 9. Since higher scores in FIG. 9 would be associated with better performance, this perspective helps appreciate that Sites 1 and 3 are doing well, Site 2 very poorly, and Site 4 not very well.

Data display can readily be further enhanced to incorporate color coding and other methods so that, especially with larger studies and many sites, outliers and other patterns may be more readily discerned.

As the study progresses, different types of errors are assessed as predictors for SPI. While some of these may be obvious in the sense that very poor performance in such type of error contributes strongly to the SPI, pattern recognition may provide additional insights and priorities for corrective intervention. Thus, referring back to FIG. 1, the next step in the method of the invention involves evaluating (or re-evaluating) 5 the best predictors in order to achieve the most informative SPI calculation. For example, a series of domains (e.g., data, procedures, safety, timing, other) may combine several measures to emphasize certain areas of performance.

A broad range of direct and indirect quality indices are calculated based on both study data and site or other performance metrics received from the field. Optimally these should be evaluated continuously and measure not only events such as when patients generate data, but also the timeliness of procedural events, timing of scheduled patient visits, and other factors related to site study performance. One of the most important benefits of this approach is to identify surrogate measures of site performance that would normally require on-site evaluation but where the surrogate measures can be measured remotely—i.e., “indirect risk indicators,” as described above.

As such predictors are identified, they can be utilized not only to guide the type and interval for field monitoring, but also to continually refine the predictive model for site quality. Changes can be incorporated into the model either by decreasing the weighting associated with a particular risk factor or by eliminating it entirely from the model. Such modeling may utilize statistical procedures such as linear or non-linear multivariable techniques. Optimally, indices of performance which do not depend on physical visits to the site are most useful, since the measurement can be executed without physical presence at the site. The type and degree of this procedure can be highly variable, depending on individual circumstances that include sponsor preferences, type of drug, phase of study, geographical distribution of sites, and other factors.

As an example, suppose that several factors that can be measured remotely are tracked, such as time between patient visit and data submission, experience of site coordinator, experience of principal investigator, geographic location (country), number of similar studies the site has conducted in the past year, and other factors. If each of these is denoted by Xᵢₙ, then key outcomes such as SPI can be measured indirectly through statistical tools such as regression, factor, discriminant, cluster, and other methods, including recursive and unsupervised machine learning methods. An example is a linear multivariable model of the form

Yᵢ=β₀+β₁Xᵢ₁+β₂Xᵢ₂+ . . . +βₚXᵢₚ⁻+εᵢ, where
Y=Summary quality measure such as SPI (dependent variable)
β=weighting factor
X=predictor variable (independent variable)
ε=Error term.

As a specific example, SPI may be found to be effectively predicted by a weighted combination of site coordinator experience, submission time, and other factors:

SPI=β₀+β₁(submission time)+β₂(coordinator experience).

For example, using the data provided above, this approach was found to predict data errors in the critical fields well enough to reduce, by 75% compared to the original starting points, the number of site visits specifically required (i.e., site visits to measure the rate of certain errors that must be checked on-site).

It will be understood that the precise mathematical relationship may also take different forms, including linear or nonlinear models that predict an ordered measure of composite risk. For example, the formula above is one example of a common starting point at the time a study may begin.

Continuing in FIG. 1, the respective SPIs and their components (e.g., domains or individual risk scores) then are compared 6 with target levels and/or rank-ordered, and either or both the interval and types of field visits can be adjusted accordingly. Thus, excellent SPIs would trigger 7 a decrease in the intensity and/or an increased interval between site visits while, in response to average SPIs, the intensity and/or interval of monitoring would remain unchanged 8. In contrast, the worst SPIs, especially those with contributions from factors that are not amenable to remote correction, would trigger 9 a more frequent visit to sites to correct quality issues (i.e., a decreased interval between site visits), with the type of monitoring determined by the types of errors. Thus, through rank ordering of SPIs, existing resources advantageously can be allocated to the worst-performing sites, in a continuous, adaptive manner throughout the study.

In a specific implementation of such an adaptive, risk-based approach to monitoring, Table 2, below, might be used as an indicator for one type of error, e.g., the number of data errors in critical fields. Based on a comparison with desired performance level (AQL), a sliding scale could be established as:

TABLE 2

| Performance | |
|---|---|
| (% AQL) | Action |
| 200 | Reduce by 75% |
| 100 | Reduce by 50% |
| 50 | Increase by 50% |
| 25 | Increase by 100% |

Thus, if performance were better than AQL, the interval for monitoring could be increased; while if poorer, then it could be decreased. This component approach could be applied to a plurality of individual risk factors, domain scores, or overall SPIs. When multiple factors are calculated (say, for individual risk factors), then the interval of monitoring would be determined by the factor that requires the most frequent visits.

As suggested above, this adaptive approach, including all steps shown in FIG. 1, can be applied iteratively during the course of a trial, so that interval of field monitoring is continually adjusted according to quality of site performance. An example is provided in Table 3, below:

TABLE 3

| | | Iteration number | | | | | |
|---|---|---|---|---|---|---|---|
| | Start | 1 | 2 | 3 | 4 | 5 | 6 |
| AQL | 20 | 20 | 20 | 20 | 20 | 25 | 25 |
| Perfor- | | 50 | 75 | 100 | 100 | 100 | 50 |
| mance | | | | | | | |
| Action | | ↑ 50% | no Δ | ↓ 50% | ↓ 50% | ↓ 50% | ↑ 50% |
| Moni- | 4 | 2 | 2 | 4 | 6 | 9 | 4.5 |
| toring | | | | | | | |
| interval | | | | | | | |
| (weeks) | | | | | | | |

As shown in Table 3, the study begins by specifying an AQL of 20 (for the particular risk factor described above (i.e., “the number of data errors in critical fields”), with a monitoring interval of every 4 weeks (this could also be another measure, such as every 4 patients seen in the study, or other units). After the first iteration, performance is noted to be 50% of AQL, and the response is to decrease the interval of visits to every two units. Each subsequent iteration produces changes based on the performance vs. AQL, and also based on the currently established interval. Note that in iteration 5, the SPI AQL is increased to 25 as a result of all sites doing better; i.e., the performance bar is raised.

The intensity (number of fields checked) and type of monitoring to be executed at each site visit can also be guided by the overall SPI, as well as by an analysis of individual risk indicators. For example, when site visits are performed, a higher frequency of error in protocol deviations would trigger a focus on data fields and procedures related to this type of error. Alternatively, a worse overall SPI for a particular site might simply serve as a trigger to increase the overall intensity of monitoring for such site.

Monitoring resources can also be adjusted. Rather than a fixed set of monitoring resources normally allocated during a study, a large number of poor SPIs can trigger additional resources (through, e.g., the hiring of temporary field monitors), while better performance might reduce monitoring resources.

Taking a final look at FIG. 1, after it has been determined whether/how to adjust monitoring in response to the ranking of the respective SPIs, further data are received. In response, various quality indices are continuously calculated and tracked 10, including trending or patterns. In addition, validation of the data and measuring 2 of error rates continues to occur at the appropriate level, followed by the other iterative steps, as described above.

### Working Example 1

In accordance with the invention, initially, a set of criteria are established, along with risk (i.e., weighting factors), Acceptable Quality Levels, and means of measurement for each. This particular Example relates to a “low-risk” study in which
Only critical data are measured (i.e., non-critical fields are not monitored).
Critical data are assessed in regard to incorrect values, missing values, and consistency. Note that many electronic data collection systems directly assess these types of errors, and facilitate immediate correction.
Nonetheless, such errors can be tracked even if corrected before the data are submitted.
AQLs are established based on a best-guess estimate.
Starting SDV is 100% of all critical values—both as a conservative measure and because of concern regarding the lack of experience with sites and site coordinators.
The key outcome is SPI, and adjustment criteria are established for performance based on this measure. In addition, sites are informed that their fees will be paid based on their respective SPIs, per Table 4, below:

TABLE 4

| SPI | Payment |
|---|---|
| >80 | 20% bonus |
| 20-80 | as agreed upon |
| <20% | 5% reduction |

These SPIs will be tracked online and will be visible to all sites as well as by the study management team and the sponsor.
Per Table 5, below, a sliding scale is established that determines the magnitude of change in interval of field monitoring based on performance, as measured by SPI:

TABLE 5

| SPI | Action |
|---|---|
| >90 | ↓ 50% |
| 70-90 | no change |
| 50-75 | ↑ 25% |
| <50 | ↑ 50% |

Each variable has its standard of comparison checked either centrally or in the field. For field visits, an initial interval of every 4 weeks or 5 patients, whichever is earlier, is established.

These initial criteria are summarized in Table 6, below:

TABLE 6

| | Error type | | | | | | | |
|---|---|---|---|---|---|---|---|---|
| | Critical Data | | | Procedural | | | | |
| | Incorrect | | | Missing | Incorrect | Missed | Missed | Incomplete |
| | value | Missing | Inconsistent | documents | documents | AE | SAE | SAE |
| Unit | Query | Query | Query | Event | Event | Event | Event | Event |
| Risk weighting | 1 | 2 | 1 | 2 | 1 | 2 | 5 | 1 |
| AQL³ | 2 | 0 | 2 | 0 | 5 | 2 | 0 | 1 |
| Starting SDV % | 100 | 100 | 100 | 100 | 100 | 100 | | 100 |
| Method of identification | Site | Central | Central | Central | Central | Site | Site | Central |
| Frequency of Measurement | 4 wk | Visit | Visit | Visit | Visit | 4 wk | 4 wk | Visit |

After several weeks of data collection, the following rates of error are measured, as shown in Table 7, below:

TABLE 7

| | Error type | | | | | | | |
|---|---|---|---|---|---|---|---|---|
| | Critical Data | | | Procedural | | | | |
| | Incorrect | | | Missing | Incorrect | | | Incomplete |
| Site | value | Missing | Inconsistent | documents | documents | Missed AE | Missed SAE | SAE |
| 1 | 2 | 0 | 0 | 0 | 0 | 0 | 0 | 0 |
| 2 | 14 | 2 | 1 | 12 | 7 | 4 | 1 | 1 |
| 3 | 6 | 0 | 2 | 2 | 0 | 0 | 0 | 0 |
| 4 | 22 | 9 | 2 | 0 | 0 | 0 | 0 | 0 |

Each value is compared with the AQL and the deviances are weighted as shown in Table 8, below:

TABLE 8

| | Error type | | | | | | | |
|---|---|---|---|---|---|---|---|---|
| | Critical Data | | | Procedural | | | | |
| | Incorrect | | | Missing | Incorrect | Missed | Missed | Incomplete |
| Deviance from AQL | value | Missing | Inconsistent | documents | documents | AE | SAE | SAE |
| AQL | 2 | 0 | 2 | 0 | 0 | 2 | 0 | 1 |
| 1 | 0 | 0 | −2 | 0 | 0 | −2 | 0 | −1 |
| 2 | 12 | 2 | −1 | 12 | 7 | 2 | 1 | 0 |
| 3 | 4 | 0 | 0 | 2 | 0 | −2 | 0 | −1 |
| 4 | 20 | 9 | 0 | 0 | 0 | −2 | 0 | −1 |
| Weighting | 1 | 2 | 1 | 2 | 1 | 2 | 3 | 1 |
| 1 | 0 | 0 | −2 | 0 | 0 | −4 | 0 | −1 |
| 2 | 12 | 4 | −1 | 24 | 7 | 4 | 3 | 0 |
| 3 | 4 | 0 | 0 | 4 | 0 | −4 | 0 | −1 |
| 4 | 20 | 18 | 0 | 0 | 0 | −4 | 0 | −1 |

Each of the scores in the bottom portion of Table 8, that have been measured for deviation from AQL and weighted, are then summed for each site to produce the aggregate SPI (except that all negative deviances are treated as zero for purposes of this calculation). Thus, the sum of scores for Site 1 is 0, Site 2 is 54, Site 3 is 8, and Site 4 is 38. To transform these to more intuitive scales, they are normed to the largest score (54, Site 2) and subtracted from 1:

Adjusted SPI=[1−(Site unadjusted SPI/maximum SPI)]×100

The adjusted (i.e., inverted and normed) SPIs are displayed in a bar graph as in FIG. 9, from which it can be seen that Site 1 executed almost flawlessly, Site 2 did terribly, Site 3 did reasonably well, and Site 4 did poorly. Based on these relative SPIs,
applying the criteria of Table 5, the interval of monitoring for Site 1 increased by 50%; for Sites 2 and 4, the interval decreased by 50%; for Site 3, the interval was unchanged; and
applying the criteria of Table 4, Sites 1 and 3 hit their bonus payment markers; Site 4 was paid according to schedule; Site 2 was financially penalized.

Within each site visit, the types and intensity of monitoring would be determined by the types of errors made. For example, in Sites 2 and 4, Incorrect Value errors are frequent (see Table 7), and the monitor could immediately contact these sites and assure their awareness of the problem and identify corrective actions. In addition, the monitor would focus on these areas at the time of site visits, along with training to assure appropriate data entry procedures. In addition, Site 2 missed two AEs and one SAE (again, per Table 7), and the definition, detection, and recording of these events would be carefully reviewed. Table 7 indicates that Site 4 has problems with both out-of-range errors (i.e., incorrect values) and missing data as well, so the invention would generate an action item for focusing assessment and training on data entry and ensuring no fields are blank. Areas where sites are performing well would receive less intensive scrutiny.

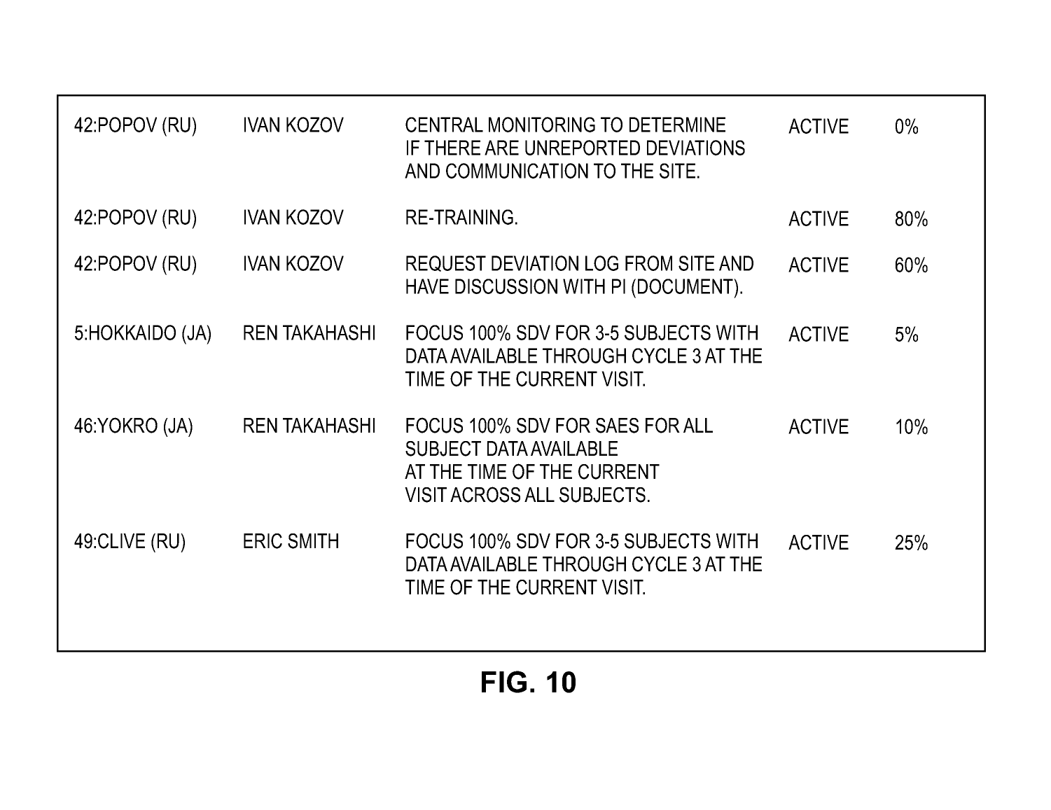

Over the next month, data quality continues to be tracked centrally, with monitor activity based on telephone follow-up, focused on the sites that perform less well. As data are processed centrally and measured against AQLs, certain errors and error patterns then are used to trigger an action item for the site monitor. Although these tasks are generally not associated with a specific time window to be addressed, the emphasis is on actions that can be taken immediately from a central location. In the study in this Example, certain actions were triggered, along with a means of tracking the status (active vs. complete) and degree of completeness, as indicated in the report shown in FIG. 10 (which is the same type of report shown in FIG. 5, as described above).

After an additional month of activity, the following rates of error are measured, as shown in Table 9, below:

TABLE 9

| | Error type | | | | | | | |
|---|---|---|---|---|---|---|---|---|
| | Critical Data | | | Procedural | | | | |
| | Incorrect | | | Missing | Incorrect | | | Incomplete |
| Site | value | Missing | Inconsistent | documents | documents | Missed AE | Missed SAE | SAE |
| 1 | 5 | 0 | 0 | 0 | 0 | 0 | 0 | 0 |
| 2 | 2 | 2 | 1 | 4 | 3 | 2 | 0 | 0 |
| 3 | 3 | 0 | 2 | 2 | 0 | 0 | 0 | 0 |
| 4 | 3 | 1 | 2 | 0 | 0 | 0 | 0 | 0 |

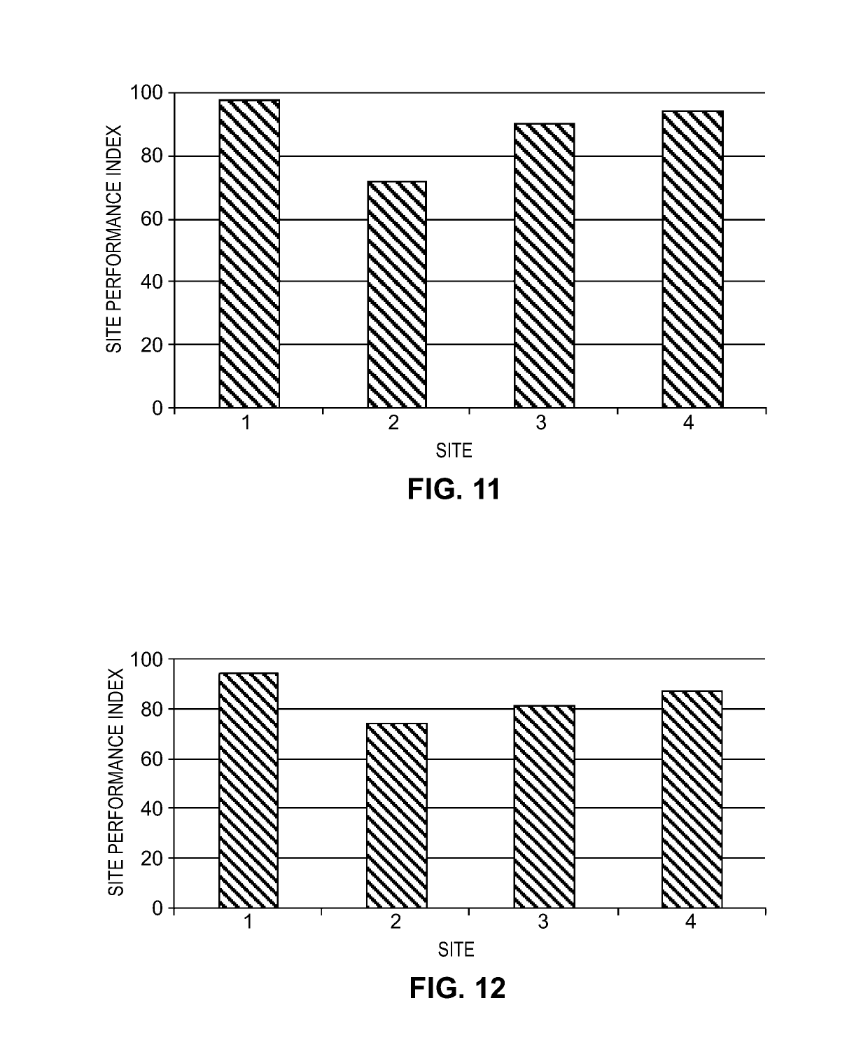

The SPIs calculated for this additional month, based on the data in Table 9, are 98 (Site 1), 72 (Site 2), 91 (Site 3), and 94 (Site 4), respectively. These SPIs are graphed in FIG. 11. (Note that SPIs are calculated separately for each month, and are not cumulative.) FIG. 11 reflects a marked improvement in Site 2 and a substantial, but less marked, improvement in Site 4. Sites 1 and 3 remain at about the same level of performance. As a result,
applying the criteria of Table 5, the interval of monitoring for Sites 1, 3, and 4 increased by 50%, because each of these sites has an SPI>90; for Site 2, monitoring interval was unchanged, because this site has an SPI=72; and
applying the criteria of Table 4, Sites 1, 3, and 4 hit their bonus markers; Site 2 was paid according to schedule.

After a third month of activity, SPIs are calculated once again, as shown in FIG. 12. Based on these SPIs, the interval of field monitoring increased in Site 1 and remained the same in Sites 2, 3 and 4.

Over time, the adjustments are summarized in Table 10, below:

TABLE 10

| Start | | Period 1 | | Period 2 | | Period 3 | |
|---|---|---|---|---|---|---|---|
| Site | Interval | SPI | Interval | SPI | Interval | SPI | Interval |
| 1 | 4 | 100 | 5 | 98 | 9 | 94 | 13.5 |
| 2 | 4 | 0 | 2 | 72 | 2 | 74 | 2 |
| 3 | 4 | 85 | 4 | 91 | 6 | 81 | 6 |
| 4 | 4 | 30 | 6 | 94 | 9 | 87 | 9 |

Interval = Duration between field monitoring visits, in weeks

This summary shows that at the beginning of the study, all sites began with field monitoring that occurred every four weeks. After the first quality assessment interval (Period 1), the interval increased in Sites 1 and 4 by 50% because of their good performance. The interval at Site 3 remained the same, while Site 2, which performed poorly, had a decrease in duration between monitoring visits to two weeks. At the second assessment (Period 2), Sites 1, 3, and 4 did well enough to have their monitoring interval increased by 50%, to 9, 6, and 9 weeks, respectively. Site 2 had no change, based on satisfactory performance, and its monitoring interval remained unchanged. At the third assessment (Period 3), Site 1 continued to perform well and again had monitoring interval increase to every 13.5 weeks, which in this instance was established as the maximum period to go between field visits, so any subsequent excellent performance for Site 1 (i.e., SPI>90) would not further increase the monitoring interval. The remaining sites had no change in their monitoring interval.

At regular intervals, a variety of variables, including many not tracked as contributing to the SPI, are explored for their ability to predict performance as measured by SPI. One of the factors tracked was found to be the strongest predictor of site performance, with a weak additional component by a second factor. Because each site performed well after the first few months, the interval of field monitoring further was increased by 25% for all sites.

### Working Example 2

This Example relates to a “high-risk” study: a dose-finding study for a new drug in a high-risk population, complicated administration of drug with individual patient titration, patients with multiple co-morbidities, multiple clinical sites of which several are new to the sponsor, site experience reasonably good but product is new to most sites. This situation might be found, for example, with a new oncology product.

Because of high risk in complexity of procedures, patient population, and importance of dose finding, initial parameters are set very tightly: the AQL is a very low or zero record of errors, a monitoring visit is scheduled following each patient visit, and the quality measure is errors discovered on-site. Since each element of data is very important, non-negative weighting (“risk”) is used, so sites have a high incentive to get every element right. Safety in particular is very important, so the adverse event (“AE”) and serious adverse event (“SAE”) parameters receive a higher than usual weighting of 5. Initial parameters, grouped into three domains, are shown in Table 11, below:

TABLE 11

| | Data Fields | | | | | | | |
|---|---|---|---|---|---|---|---|---|
| | Critical | Non-critical | Inconsistent | Procedural | | Safety | | |
| Quality Measure | Data query | Data query | Data query | Missing | Incorrect | Missed AE | Missed SAE | Incomplete SAE |
| Risk² | 3 | 2 | 3 | 3 | 3 | 4 | 5 | 5 |
| AQL³ | 1 | 2 | 1 | 0 | 0 | 1 | 0 | 0 |
| Starting SDV Percentage | 100 | 100 | 100 | 100 | NA | 100 | 100 | 100 |
| Method of identification | Onsite | Onsite | Onsite | Onsite | Onsite | Onsite | Onsite | Onsite |
| Frequency of | Pt visit | Pt visit | Pt visit | Pt visit | Pt visit | Pt visit | Pt visit | Pt visit |
| Measurement | | | | | | | | |

The first 10 patients are monitored intensely, with the result that two of the four sites stand out for discrepancies, as shown in Table 12, below:

TABLE 12

| | Data Fields | | | | | | | | |
|---|---|---|---|---|---|---|---|---|---|
| | Critical | Non-critical | Inconsistent | Procedural | | Safety | | | |
| Site | Data query | Data query | Data query | Missing | Incorrect | Missed AE | Missed SAE | incomplete SAE | SPI |
| 1 | 2 | 2 | 0 | 0 | 0 | 0 | 0 | 0 | 3 |
| 2 | 2 | 5 | 4 | 1 | 1 | 1 | 1 | 1 | 28 |
| 3 | 2 | 2 | 0 | 0 | 0 | 0 | 0 | 0 | 3 |
| 4 | 1 | 2 | 0 | 3 | 2 | 3 | 3 | 0 | 38 |

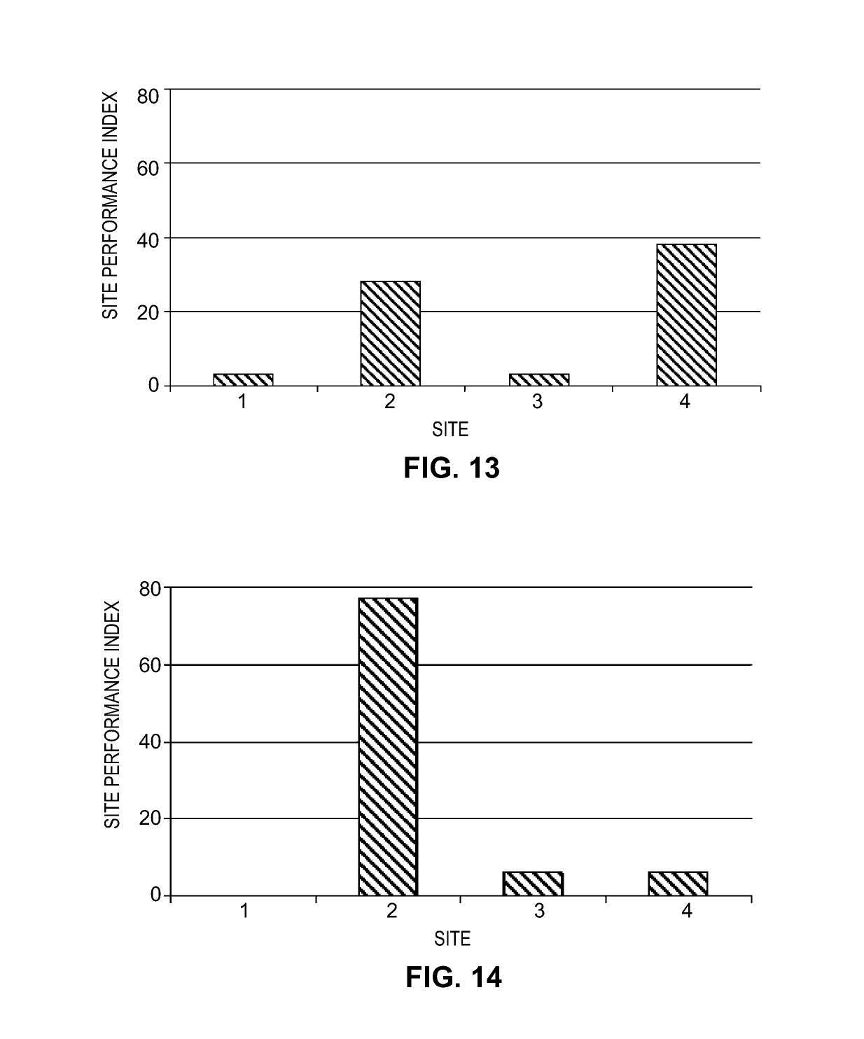

The respective SPIs are graphically represented in FIG. 13. Note that this example uses a “raw” SPI index that is unadjusted (i.e., not inverted and not normed), so higher SPIs indicate worse performance. The starting scale of 80 was selected arbitrarily.

Of interest in Table 12 is the fact that each of these sites has different issues: Of the worst performing sites, Site 2 primarily has data collection and validation problems, while Site 4 has more problems related to safety. The consequence of these is that each site gets slightly different training. In the case of Site 2, the appropriate corrective action is on-site training for the data management personnel. Since Site 4's problems are more centrally related to the performance of the drug, these are judged to be more serious and to require closer attention, albeit more amenable to remote monitoring, since safety issues are more amenable to remote monitoring (while those at Site 2 more require on-site monitoring and training).

In this case, multivariable linear analysis as described above was used as a tool to identify the independent contribution of each of several domains. The variables under each were grouped and then analyzed, which produced the set of p-values shown in Table 13, below. The lower p-values indicate a stronger association with a higher (worse) SPI, after adjusting for each of the other variables in the model:

TABLE 13

| Site | Data | Quality | Timing |
|---|---|---|---|
| 1 | 0.14 | 0.44 | 0.32 |
| 2 | 0.32 | 0.58 | 0.23 |
| 3 | 0.12 | 0.22 | 0.32 |
| 4 | 0.12 | 0.24 | 0.02 |

Based on the correlation factors in Table 13, at Sites 1 and 3 the main problem is data management, but these problems are closely related to timing of submissions. Since these two factors are closely related, and timing tends to predict data issues but does not require on-site presence to measure, physical monitoring interval is increased 50% for Sites 1 and 3, remains the same for Site 2, and is increased 25% for Site 4.

After an additional 10 patients (n=20), the respective SPIs are shown in FIG. 14, from which it can be seen that performance at Site 2 deteriorated, Site 4 improved, and Sites 1 and 3 continued to do well. Monitoring interval at Site 2 therefore is decreased by 25%; monitoring interval is increased by an additional 50% for Sites 1 and 3, and increased by 50% for Site 4.

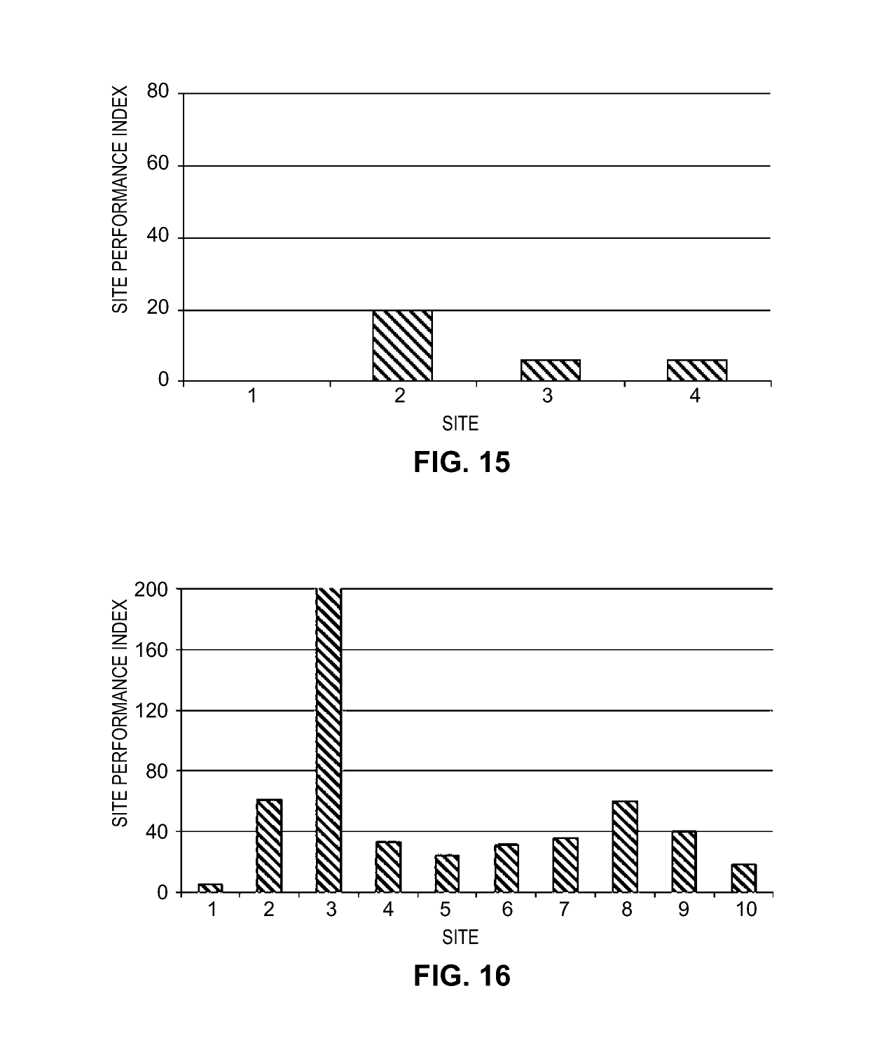

Following an additional 10 patients (n=30), the new SPIs are shown in FIG. 15. It is now apparent that performance for Site 2 has improved markedly, while the remaining sites continue to do well. Monitoring interval is increased by 50% for Site 2 and remains unchanged for Sites 1, 3, and 4, as it is felt that the monitoring interval for these sites should not be increased.

### Working Example 3

This Example relates to a “moderate-risk” study: a registration (Phase III) study involving more than 100 sites in five countries. The product is in a category that is well known, and there is substantial experience from earlier work with this product, which is being evaluated in a population of middle-aged subjects without significant co-morbidities. For simplicity of illustration, 10 sites are shown in this example; i.e., two for each country. For this study, data flow and timeliness as well as quality are deemed important, so equal weighting is assigned to each of the factors, as in Working Example 2. Two additional risk factors are used to evaluate site performance: timing of submission of data (i.e., the time interval between when a patient is seen and data are submitted) and timing of error corrections (i.e., the time interval between when queries are sent to a site and corrections are completed). The initial monitoring interval is set at every four weeks. As in Working Example 2, the SPI here is unadjusted (i.e., not inverted), so higher SPIs indicate worse site performance. In addition, payment has been added as a factor to this study, so sites are informed that they will receive a 10% bonus for each payment if their Site Performance Index is less than 20.

After the first two months of study operations, the number of discrepancies at different sites is quite variable, with sites falling into several categories of error patterns, as shown in Table 14, below.

TABLE 14

| | Data Fields (Errors per 100 fields) | | | | | Safety | | | Timing (days) | |
|---|---|---|---|---|---|---|---|---|---|---|
| | Critical | Non-critical | Inconsistent | Procedural | | | | Incomplete | Time to | |
| Site | Data query | Data query | Data query | Missing | Incorrect | Missed AE | Missed SAE | SAE | Submission | Time to Corrections |
| 1 | 0 | 0 | 0 | 0 | 0 | 0 | 0 | 0 | 0.5 | 1 |
| 2 | [symbol] | [symbol] | 4 | 1 | 1 | 1 | 1 | 1 | 4 | 10 |
| 3 | 10 | 12 | 4 | 2 | [symbol] | 12 | 2 | 4 | 18 | 25 |
| 4 | 1 | 2 | 0 | [symbol] | 2 | [symbol] | 3 | 0 | 2 | 2 |
| 5 | 5 | 2 | 0 | 0 | 0 | 1 | 0 | 1 | 2 | 1 |
| 6 | [symbol] | [symbol] | 0 | 0 | 0 | 2 | 0 | 0 | [symbol] | 5 |
| 7 | 7 | 5 | 1 | 1 | 2 | 1 | 0 | 0 | 2 | 2 |
| 8 | 9 | 4 | 0 | 2 | 1 | 1 | 1 | 2 | 2 | 5 |
| 9 | 4 | 0 | 0 | 0 | 0 | 2 | 0 | 0 | 5 | 5 |
| 10 | 5 | 2 | 1 | 0 | 0 | 1 | 0 | 0 | 1 | 1 |

[symbol]

indicates data missing or illegible when filed

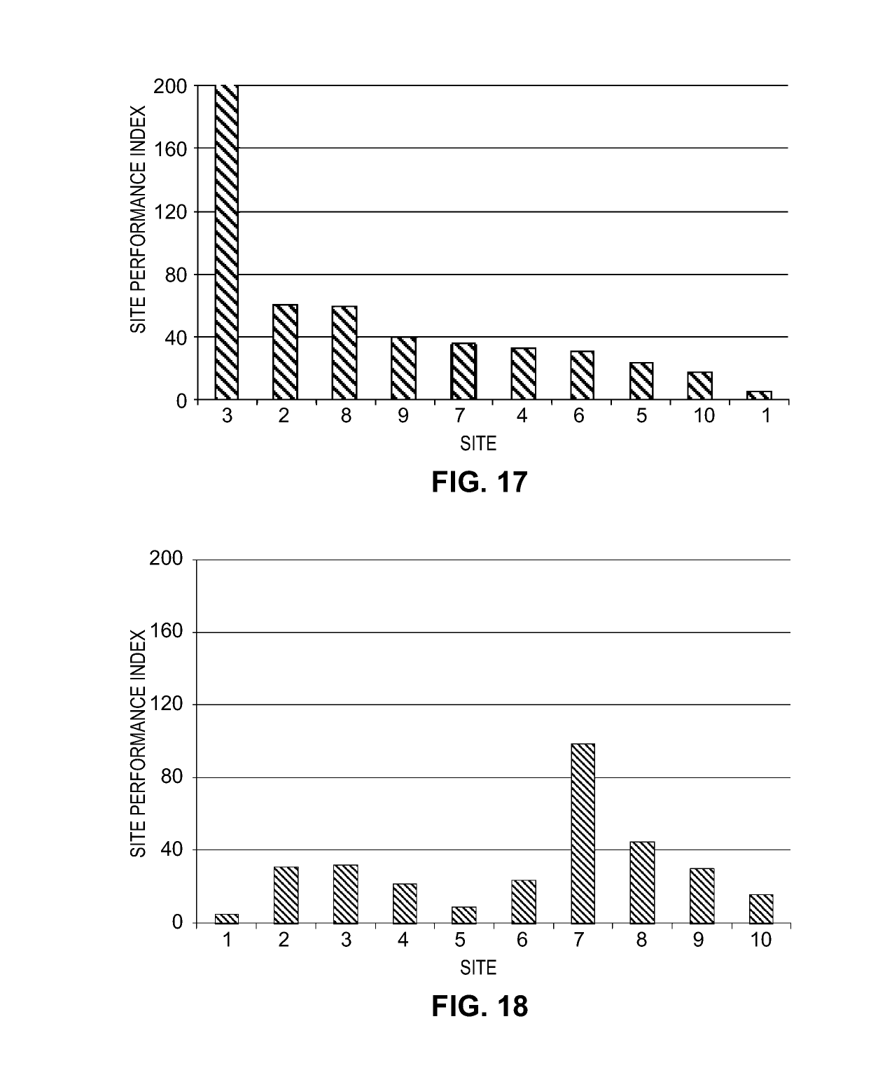

The respective SPIs, calculated based on the data in Table 14, are presented in FIG. 16. Overall, the sites are doing fairly well, with Sites 1 and 10 doing the best—well enough to meet the bonus criteria. Sites 4, 5, 6, 7, and 9 are doing reasonably well; Sites 2 and 8, not as well; and Site 3 is clearly doing the worst. Sites 2, 3 and 8 are highest priority for management to improve performance, clearly reflected by rank ordering the sites by SPI as shown in FIG. 17—a technique that is useful when many sites are included.

Based on FIG. 17, Site 3 is the highest priority for attention, and examination of the factors in Table 14 reveals that it is doing poorly across the board, in all categories. This is worrisome and a flag for intervention at the highest levels; i.e., the central site manager must determine how to address these poor performance indicators that seem to be consistent. This indicates a need to decrease the monitoring interval and increase the amount of information monitored, so the site manager decreases the interval of monitoring to every two weeks.

Site 2's problem, as indicated in Table 14, seems to lie primarily with responsiveness in submitting data and responding to queries. As a result, the central site manager increases the frequency of telephone contact with the site, but does not have to go to the site more often. The interval of monitoring remains unchanged at every 4 weeks.

According to Table 14, Site 8 is having problems with a high number of queries for critical data fields and in time of data submission. Both problems trigger a note for the central site manager to contact the site at least every other day. The interval of field monitoring remains unchanged.

Remaining Sites 4, 6, 7, and 9 are doing adequately, but across the board could be better. The interval of field monitoring remains the same for these sites. Sites 1, 5, and 10 are doing well, and their monitoring interval is increased by 50%, to every 8 weeks.

After an additional month, the SPIs are recalculated, as shown in FIG. 18. At this time, most sites, notably including Site 3, have improved substantially, and three sites are meeting the bonus criteria (Sites 1, 5, 10); two more (Sites 4, 6) are close to meeting the bonus criteria. Site 7 is doing worst because of delays in submitting information, but interestingly, is doing well on quality measures.

All sites except Site 8 are doing well on the data metrics, and the monitoring interval is increased at Sites 4 and 6 by 50%, to every six weeks, and at Site 3 by 50%, from every two weeks to every three weeks. Other sites remain unchanged. However, it is apparent that Site 7, which had been doing well, is doing worse, and examination reveals both data and time issues. The centralized study manager discovers that the site added new personnel in the form of a new data manager in order to allow their site coordinator to focus on patient care. However, the new data manager's lack of familiarity with the specifics of this study has become an issue, reflected by poorer SPI and domain subscores on data quality and timeliness. As a consequence, the centralized study manager immediately schedules a visit to the site to review data handling procedures, and decreases the interval of field visits to every 2 weeks.

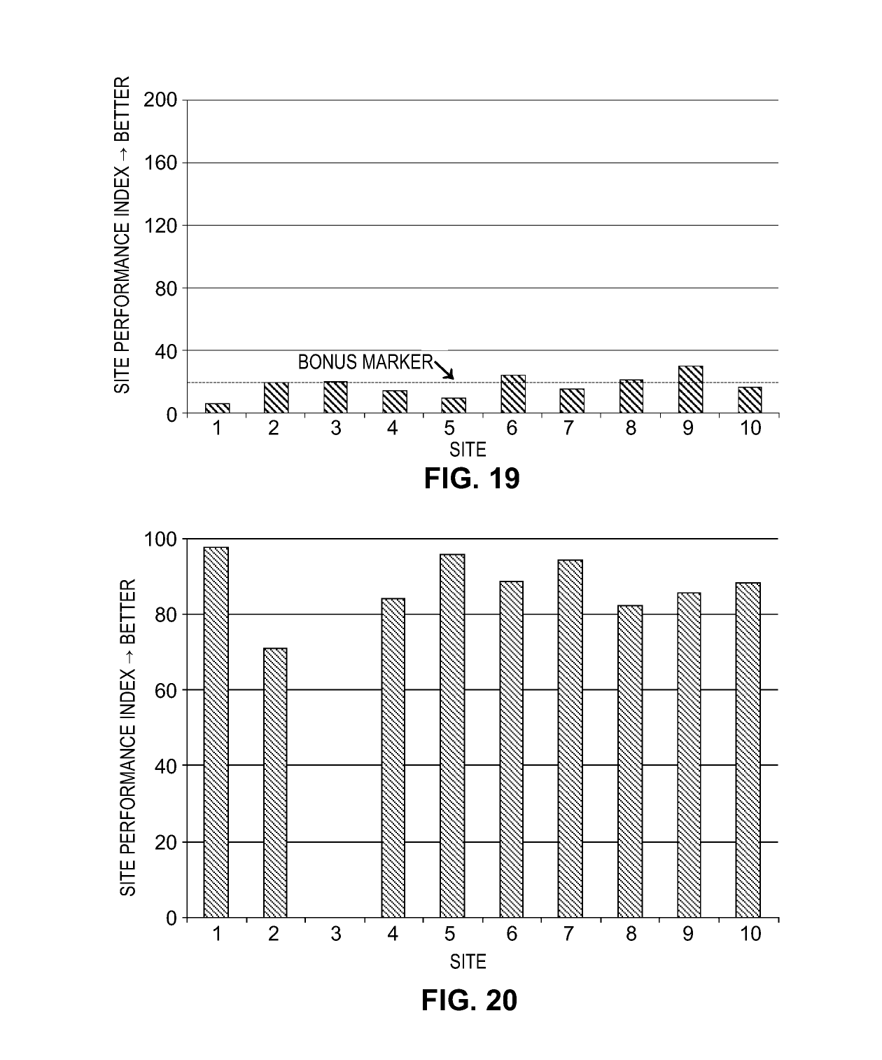

After an additional month, Site 7's performance has improved considerably, and Site 3's improvement has also continued (see FIG. 19). All sites are doing quite well now, with six sites hitting their performance bonus markers; the four that failed to do so did not miss by much. Sites 3 and 7's monitoring interval is increased to every 4 weeks; Site 5, to every 12 weeks; Site 8, to every 6 weeks; and Sites 2 and 4, to every 8 weeks. Sites 6 and 9 remain the same, at every 6 and 4 weeks, respectively. Sites 1 and 10 remain unchanged at 8 weeks.

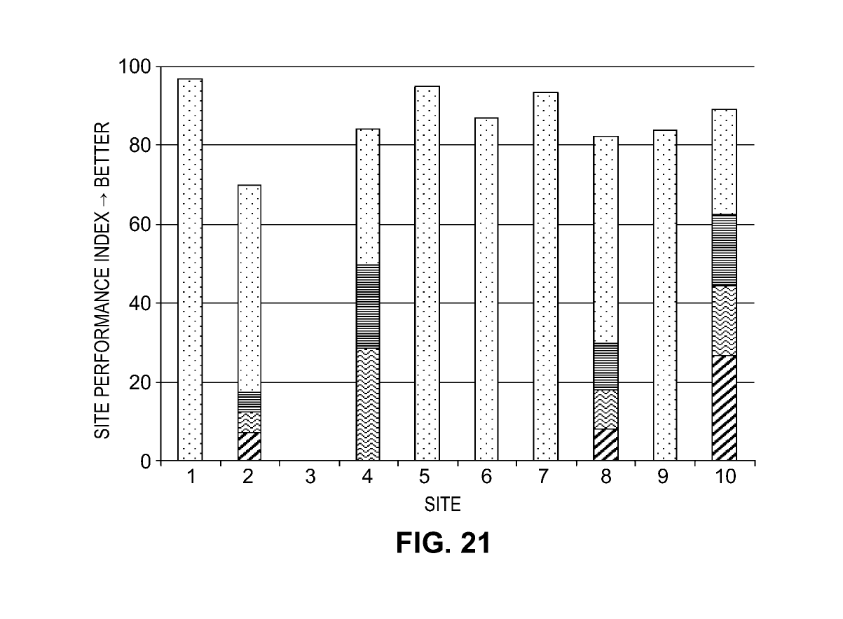

It should be noted that there are numerous alternative ways of examining data such as those in this Example. Thus, the SPIs presented in FIG. 16 may be both normed and inverted so that the best performing site sets the standard SPI of 100 at the first iteration. In this case, a higher SPI value represents better performance (as opposed to the case with the “raw” SPIs shown in FIG. 16, where a higher value represents worse performance). These adjusted SPIs are shown in FIG. 20. Alternatively, for the same time period, one might utilize a more diagnostic display that includes component domain scores for data (dots), procedure (horizontal lines), safety (wavy lines), and timing (diagonal lines), as shown in FIG. 21.

The foregoing description details certain embodiments of the invention. It will be appreciated, however, that the invention can be practiced in many ways. It also should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A risk-based, computer-assisted method for adaptively adjusting the interval and/or intensity of field monitoring in a medical clinical trial conducted at one or more sites, said method comprising the steps of:
(a) specifying
(i) one or more risk factors, each associated with a type of error likely to be made during performance of the clinical trial,
(ii) a weighting factor for each risk factor, based on the degree of importance of such risk factor,
(iii) an Acceptable Quality Level for each risk factor, wherein such Acceptable Quality Level represents an acceptable error rate, and
(iv) an initial interval and intensity of field monitoring for one or more sites participating in the clinical trial;
(b) measuring the error rate for each type of error or risk factor for one or more sites; and, optionally,
(c) based on the nature and extent of errors measured in step (b), generating a list of corrective actions to be taken at or by one or more of the sites.

2. The method of claim 1, wherein step (b) further comprises
(i) comparing such error rate with the corresponding Acceptable Quality Level for the applicable risk factor, and
(ii) calculating a discrepancy score based on the difference between the error rate and the corresponding Acceptable Quality Level for such risk factor.

3. The method of claim 2, further comprising the step of:
(d) calculating a site performance index for one or more sites, based on the discrepancy scores calculated in step (b)(ii) for each risk factor, with each such discrepancy score weighted according to the weighting factor specified in step (a)(ii).

4. The method of claim 3, further comprising the steps of:
(e) comparing the site performance indices for one or more sites, by ranking the respective site performance indices or comparing each to a desired standard of performance, in order to differentiate better-performing from worse-performing sites; and, optionally,
(f) analyzing the respective site performance indices in order to evaluate (or re-evaluate) the risk factors most predictive of site performance.

5. The method of claim 4, further comprising the step of:
(g) increasing, decreasing, or maintaining the intensity and/or interval of field monitoring at one or more sites, based on (i) the respective site performance indices and/or (ii) the nature of the errors measured at the respective sites.

6. The method of claim 5, further comprising the steps of:
(h) measuring various additional quality indices, including trend or pattern information, observed during the continued performance of the clinical trial; and optionally,
(i) analyzing the quality indices or trend or pattern information in order to evaluate (or re-evaluate) the most predictive risk factors for determination of site performance.

7. The method of claim 1, wherein step (a)(iv) further comprises evaluating background risk factors and/or the nature of the data to be obtained in the clinical trial.

8. The method of claim 1, wherein the risk factors are selected from the group consisting of data recording errors, procedural errors, and non-data (or meta-data) events.

9. The method of claim 1, wherein the corrective actions are selected from the group consisting of (i) actions that can be addressed immediately and/or remotely and (ii) actions that require on-site activity.

10. The method of claim 1, wherein all or part of the list of corrective actions is generated by software that has been pre-programmed to address errors that are commonplace in clinical trials.

11. The method of claim 1, wherein step (c) further comprises the use of software to automatically schedule the performance of said corrective actions.

12. The method of claim 4, wherein step (f) further comprises generating a linear or non-linear multivariable model for calculation of site performance indices.

13. The method of claim 6, wherein step (i) further comprises generating a linear or non-linear multivariable model for calculation of site performance indices.

14. The method of claim 12, wherein the model is refined by replacing (i) measures of site performance that normally would require on-site evaluation, with (ii) surrogate measures of site performance that can be measured remotely.

15. The method of claim 13, wherein the model is refined by replacing (i) measures of site performance that normally would require on-site evaluation, with (ii) surrogate measures of site performance that can be measured remotely.

16. The method of claim 5, wherein step (g) further comprises paying a financial performance “bonus” to one or more better-performing sites and/or applying a financial “penalty” to one or more worse-performing sites.
